(19) United States
(12) Patent Application Publication
(10) Pub. No.: US 2025/0245420 A1
(43) Pub. Date: Jul. 31, 2025

(54) SYSTEM AND METHOD FOR AUTOMATIC MODIFICATION OF PROMPTS AND CONTENT ITEMS

(71) Applicant: Yahoo Ad Tech LLC, New York, NY (US)

(72) Inventors: Eric T Bax, Sierra Madre, CA (US); Arundhyoti Sarkar, Mountlake Terrace, WA (US); Charlotte Bax, Houston, TX (US); Melissa Gerber, Rancho Mission Viejo, CA (US); William W Wagner, Cosa Mesa, CA (US); Nikki Thompson, Bloomfield, NJ (US); Ruchita Garde, Jersey City, NJ (US)

(21) Appl. No.: 18/422,110

(22) Filed: Jan. 25, 2024

(51) Int. Cl. G06F 40/166; G06F 16/9535; G06F 40/134

(52) U.S. Cl. CPC G06F 40/166; G06F 16/9535; G06F 40/134

(57) ABSTRACT

In an example, a prompt for a generative AI tool may be received from a client device. A first prompt modification profile matching the prompt may be identified. The prompt may be modified based upon the first prompt modification profile to generate an updated prompt. Using the generative AI tool, a first content item may be generated based upon the updated prompt. A first content modification profile matching at least a portion of the first content item may be identified. The first content item may be modified based upon the first content modification profile to generate an updated content item. The updated content item may be provided for presentation on the client device.

### BACKGROUND

Many services, such as websites, applications, etc. may provide platforms for viewing media. For example, a user may interact with a service. While interacting with the service, selected media may be presented to the user automatically.

### SUMMARY

In accordance with the present disclosure, one or more computing devices and/or methods are provided. In an example, a prompt for a generative artificial intelligence (AI) tool may be received from a client device. A database comprising prompt modification profiles may be accessed to identify a first prompt modification profile matching the prompt. The prompt may be modified based upon the first prompt modification profile to generate an updated prompt. A first content item may be generated using the generative AI tool based upon the updated prompt. The first content item may be provided for presentation on the client device.

In an example, a prompt for a generative AI tool may be received from a client device. A first content item may be generated using the generative AI tool based upon the prompt. A database comprising content modification profiles may be accessed to identify a first content modification profile comprising a first key matching at least a portion of the first content item. The first content item may be modified based upon the first content modification profile to generate an updated content item. The updated content item may be provided for presentation on the client device.

In an example, a prompt for a generative AI tool may be received from a client device. A first prompt modification profile matching the prompt may be identified. The prompt may be modified based upon the first prompt modification profile to generate an updated prompt. Using the generative AI tool, a first content item may be generated based upon the updated prompt. A first content modification profile matching at least a portion of the first content item may be identified. The first content item may be modified based upon the first content modification profile to generate an updated content item. The updated content item may be provided for presentation on the client device.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for modifying prompts and/or content items.

FIG. 5A is a component block diagram illustrating an example system for modifying prompts and/or content items, where a content interface is displayed on a first client device.

FIG. 5B is a component block diagram illustrating an example system for modifying prompts and/or content items, where a prompt is received from a first client device.

FIG. 5C is a component block diagram illustrating an example system for modifying prompts and/or content items, where one or more prompt modification profiles are selected for use in modifying a prompt.

FIG. 5D is a component block diagram illustrating an example system for modifying prompts and/or content items, where a prompt is modified based upon a prompt modification profile.

FIG. 5E is a component block diagram illustrating an example system for modifying prompts and/or content items, where a generative artificial intelligence (AI) tool is used to generate a content item based upon an updated prompt.

FIG. 5F illustrates an example representation of a content item generated by a generative AI tool.

FIG. 5G illustrates an example representation of a content item generated by modifying a content item based upon a content configuration of a prompt modification profile.

FIG. 5H is a component block diagram illustrating an example system for modifying prompts and/or content items, where one or more content modification profiles are selected for use in modifying a content item.

FIG. 5I is a component block diagram illustrating an example system for modifying prompts and/or content items, where a content item is modified based upon a content modification profile to generate an updated content item.

FIG. 5J illustrates an example representation of an updated content item generated by modifying a content item based upon a content modification profile.

FIG. 6 is a flow chart illustrating an example method for modifying prompts.

FIG. 7 is a flow chart illustrating an example method for modifying content items.

FIG. 8 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

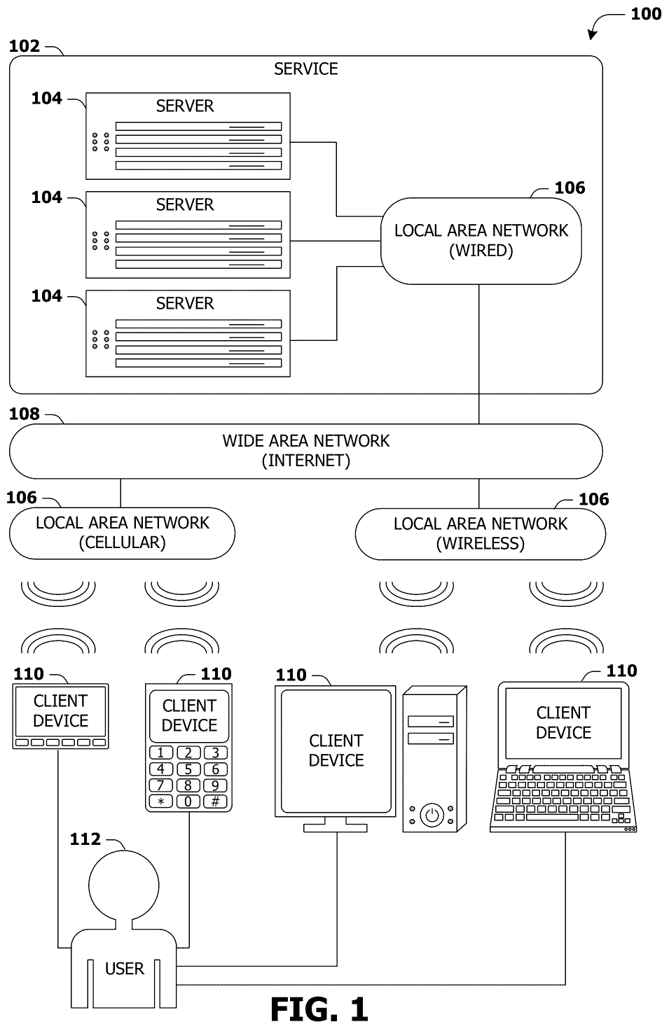

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

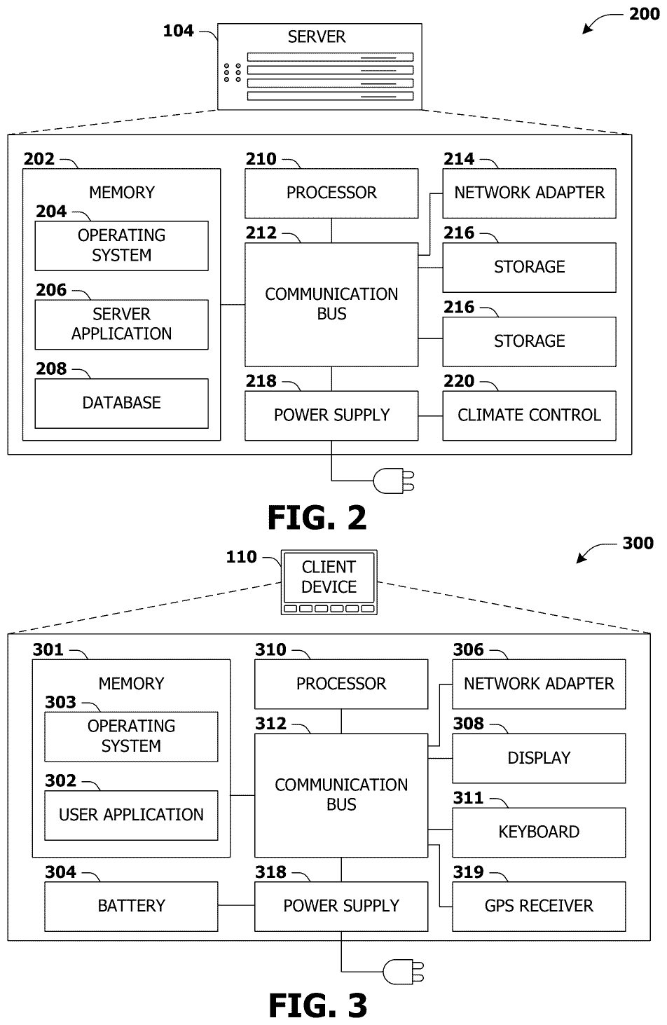

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for automatic modification of prompts and/or content items are provided. For example, a user (and/or a device associated with the user) may access and/or interact with a service, such as a browser, software, a website, an application, an operating system, etc. that provides a platform for interacting with a generative artificial intelligence (AI) tool of a content system. The content system may provide a service that provides content items (e.g., AI-generated content items) based upon prompts received from the user. In some examples, the content system may provide a service to automatically modify an incoming prompt to generate customized and/or personalized content items. In an example, a prompt received may be supplemented with an indication of an entity (e.g., a brand, a product, a service, etc.) to generate an updated prompt, which may be submitted to the generative AI tool to produce a content item that includes content associated with the entity. The content item may be provided to the user. Alternatively and/or additionally, the content item may supplement the content item with one or more supplemental content items to produce an updated content item, which may be presented to the user. In some examples, the content system may provide a service to automatically modify content items generated by the generative AI tool to generate customized and/or personalized content items. In an example, the content system may compare a content item generated by the generative AI tool may with various content modification profiles to identify a matching content modification profile. The content system may automatically modify the content item based upon the matching content modification profile to produce an updated content item, which may be presented to the user. The updated content item may include one or more supplemental content items. The present disclosure may be used to provide the user with supplemental content (e.g., advertisements, informational content, entertainment, etc.) tool in a contextual manner and/or without interrupting activity of the user while the user interacts with the generative AI.

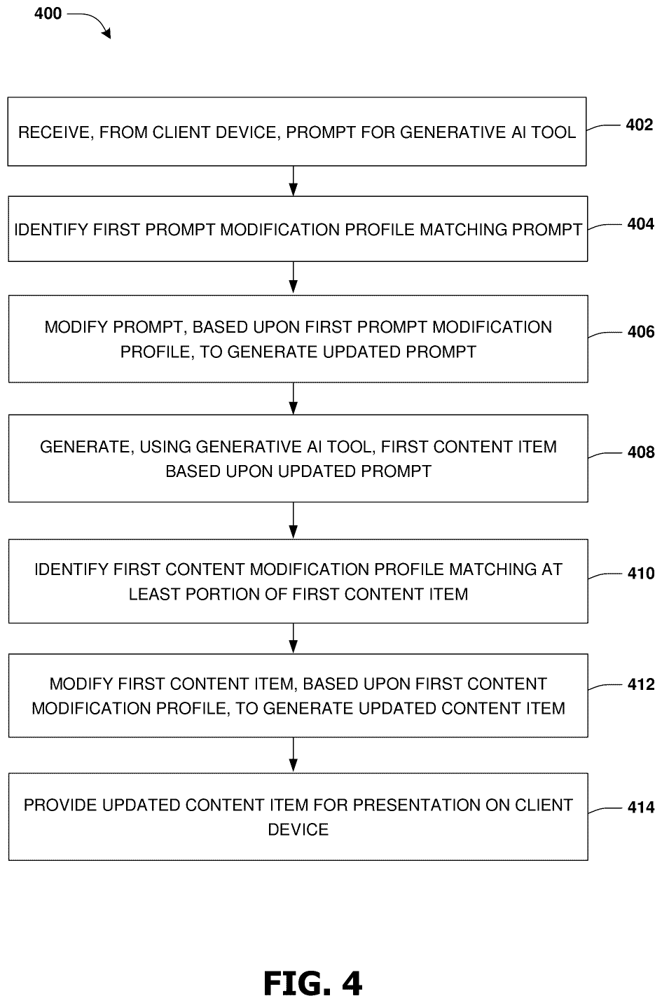

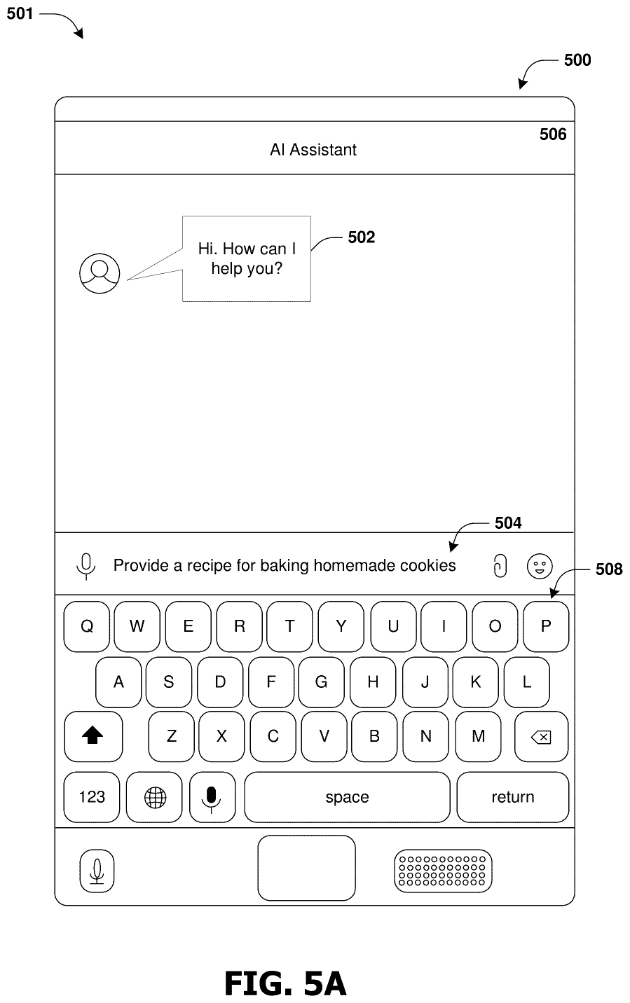

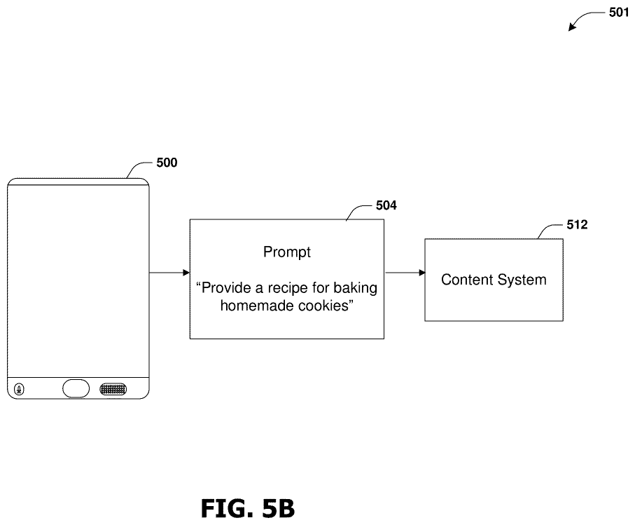

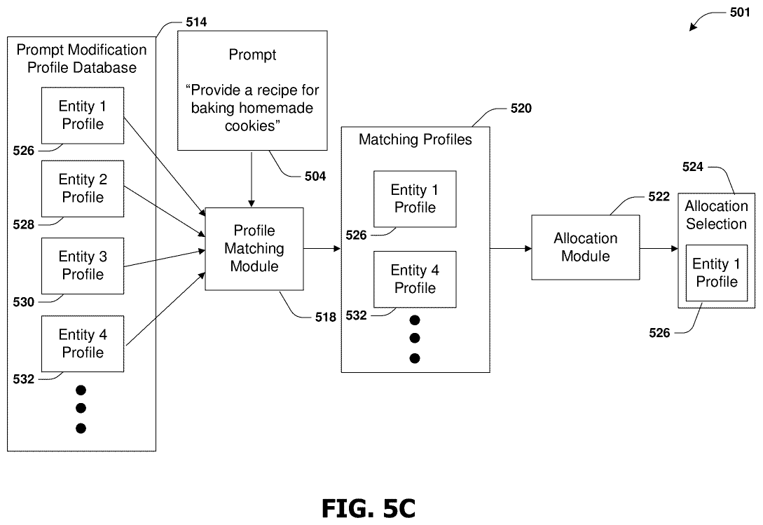

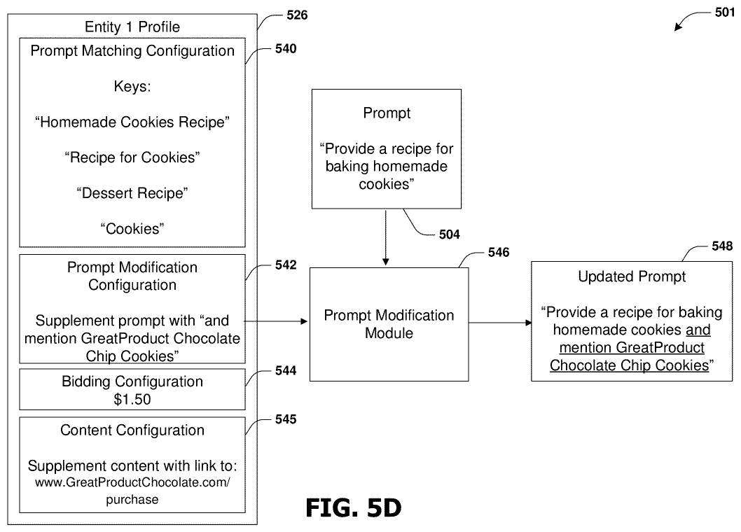

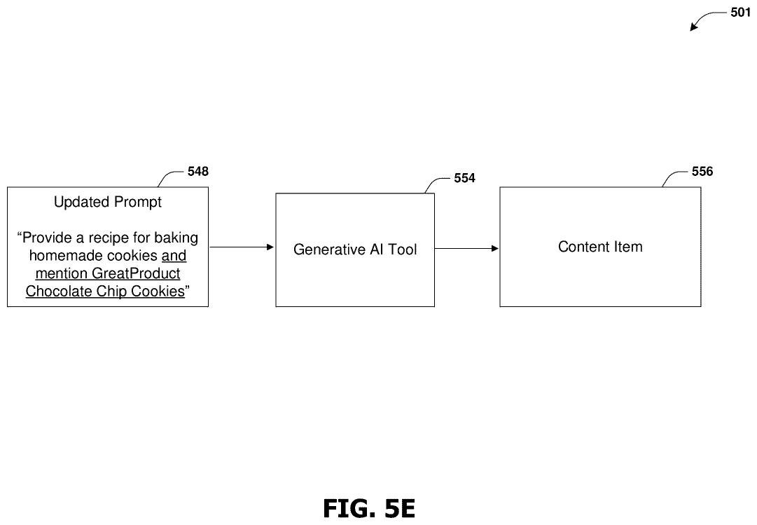

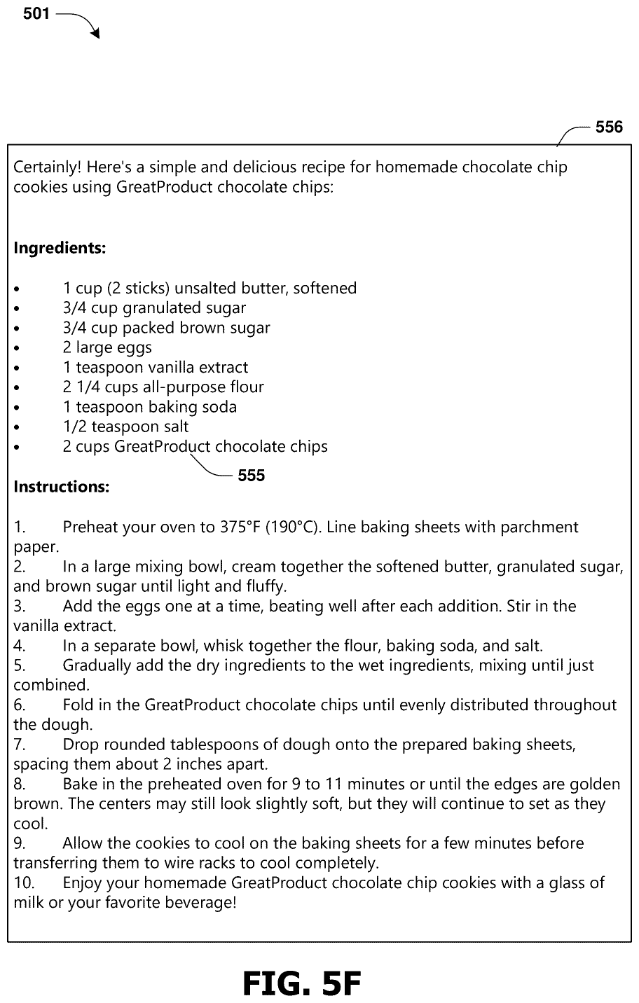

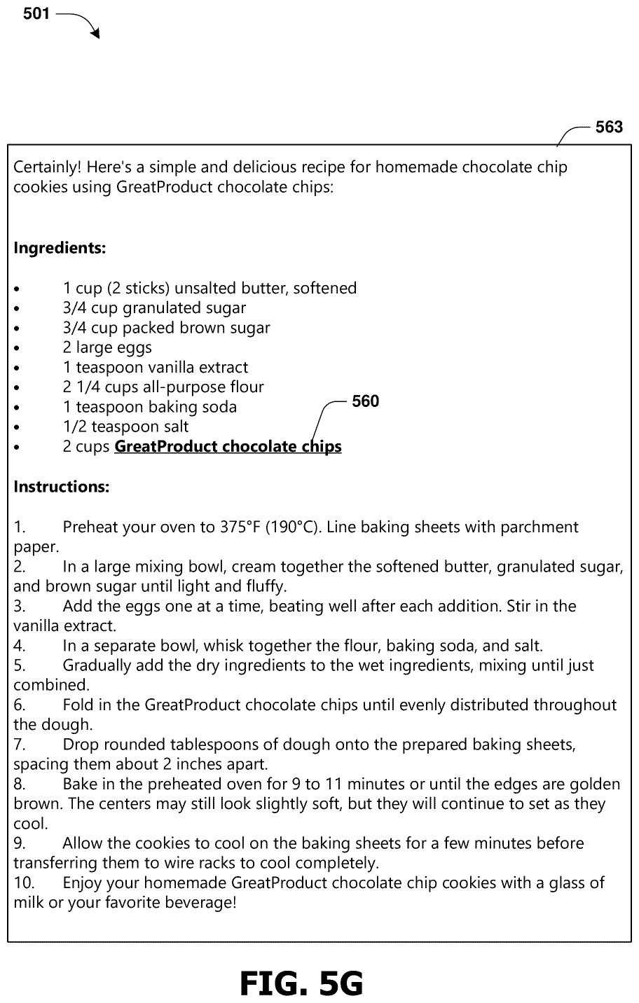

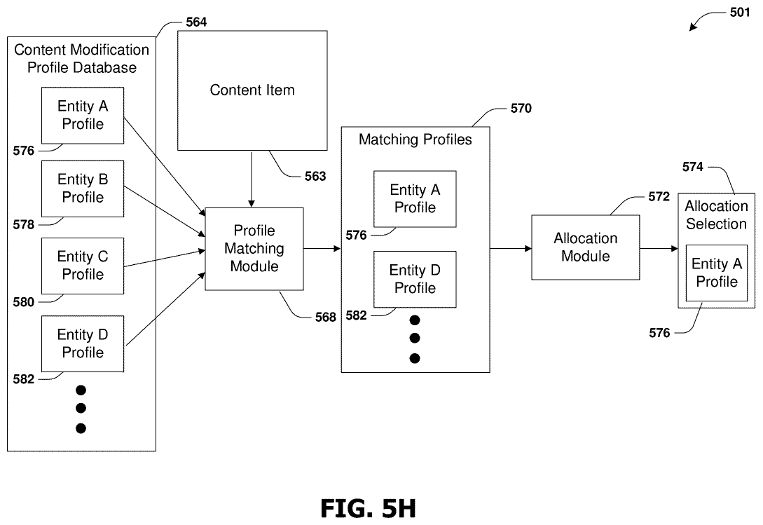

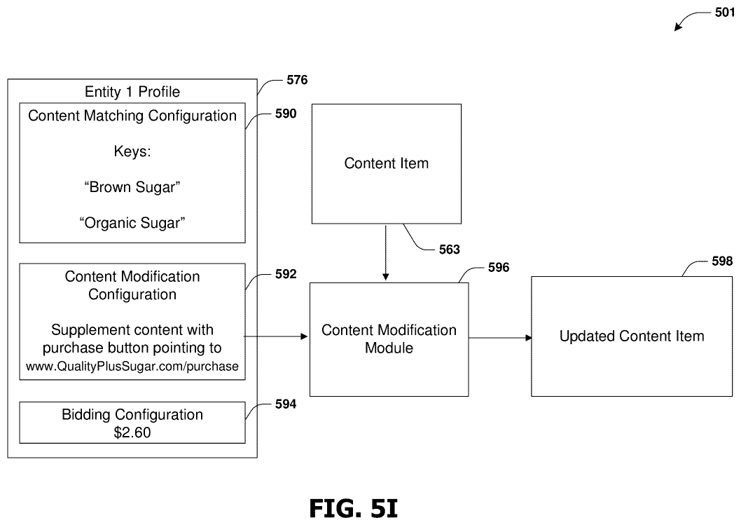

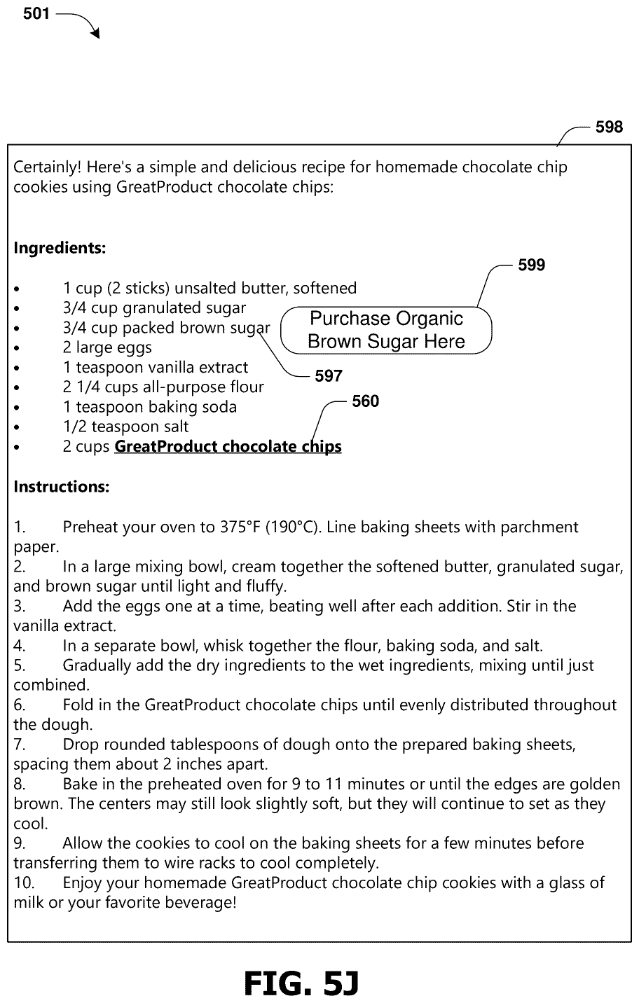

An embodiment of automatically modifying prompts and/or content items is illustrated by an example method 400 of FIG. 4, and is further described in conjunction with a system 501 of FIGS. 5A-5J. In some examples, a content system is provided. A first user, such as user Jill, (and/or a first client device associated with the first user) may access and/or interact with a service, such as a browser, software, a website, an application, an operating system, an email interface, a messaging interface, a music-streaming application, a video application, a news application, an augmented reality (AR) application, a mixed reality (MR) application, a virtual reality (VR) application, etc. that provides a platform for viewing and/or downloading content items (e.g., sets of text, images, audio, videos, AR content, MR content, VR content, interactive content, dynamic content, etc.) from a server associated with the content system. In some examples, the content system may use user information, such as a first user profile comprising activity information (e.g., search history information, website browsing history, email information, selected content items, etc.), demographic information associated with the first user, health information associated with the user, location information, etc. to determine interests of the first user and/or select content for presentation to the first user based upon the interests of the first user.

In an example, the content system may comprise a generative artificial intelligence (AI) tool used to generate content items (e.g., content items comprising at least one of text, images, audio, video, AR content, MR content, VR content, interactive content, dynamic content, etc.) in response to prompts (input by users of the content system, for example). In some examples, the generative AI tool may comprise a chatbot (also known as chatterbot). The generative AI tool may comprise one or more generative models (e.g., generative AI models) used to generate a content item based upon a prompt.

FIG. 5A illustrates a content interface 506 displayed via the first client device (shown with reference number 500) associated with the first user. The first client device 500 may comprise at least one of a phone, a laptop, a computer, a wearable device, a smart device, a television, any other type of computing device, hardware, etc. The content interface 506 (e.g., at least one of an AI assistant interface, a chatbot interface, etc.) may be used for receiving one or more messages (e.g., one or more prompts) input via the first client device 500 (e.g., the one or more messages may be input by the first user). The content interface 506 may be used by the first user to interact with the generative AI tool of the content system. In an example, in FIG. 5A, a first message 502 (generated by the generative AI tool of the content system, for example) may be transmitted to the first client device 500 and/or displayed via the content interface 506 (e.g., the first message 502 may be displayed as a starting message of a conversation between the first user and the generative AI tool).

In some examples, a first prompt 504 may be input by the first user by typing the first prompt 504 into the content interface 506 using a keyboard (e.g., at least one of a physical keyboard, a touchscreen keyboard 508 shown in FIG. 5A, etc.). Alternatively and/or additionally, a voice recognition system may be used to convert audible speech recorded by the first client device 500 into the first prompt 504. At 402 of FIG. 4, the content system may receive the first prompt 504 from the first client device 500. FIG. 5B illustrates reception of the first prompt 504 (e.g., “Provide a recipe for baking homemade cookies”) by a server 512 of the content system.

At 404 of FIG. 4, the content system may identify a set of matching prompt modification profiles (e.g., set of one or more prompt modification profiles) matching the prompt. For example, the content system may access a prompt modification profile database comprising a plurality of prompt modification profiles to identify the set of matching prompt modification profiles matching the prompt. The prompt modification profile database may be stored on one or more first data stores. In some examples, the plurality of prompt modification profiles may be associated with a first plurality of entities. An entity of the first plurality of entities may correspond to at least one of an advertiser, a campaign of an advertiser, a company, a sponsor, a brand, an organization, a source of information, a publisher, a content creator, etc. FIG. 5C illustrates a profile matching module 518 used to identify the set of matching prompt modification profiles (shown with reference number 520). The prompt modification profile database (shown with reference number 514) may comprise at least one of a first prompt modification profile 526 associated with a first entity “Entity 1” (e.g., a first advertiser, campaign, company, brand, organization, source of information, publisher, and/or content creator), a second prompt modification profile 528 associated with a second entity “Entity 2” (e.g., a second advertiser, campaign, company, sponsor, brand, organization, source of information, publisher, and/or content creator), a third prompt modification profile 530 associated with a third entity “Entity 3”, a fourth prompt modification profile 532 associated with a fourth entity “Entity 4”, etc.

The profile matching module 518 may scan the prompt modification profiles of the prompt modification profile database 514 based upon the first prompt 504 to identify the set of matching prompt modification profiles 520. For example, the profile matching module 518 may compare the first prompt 504 with the prompt modification profiles of the prompt modification profile database 514 to identify the set of matching prompt modification profiles 520. In some examples, the profile matching module 518 may (i) include the first prompt modification profile 526 in the set of matching prompt modification profiles 520 based upon a determination that the first prompt modification profile 526 matches the first prompt 504, (ii) include the fourth prompt modification profile 532 in the set of matching prompt modification profiles 520 based upon a determination that the fourth prompt modification profile 532 matches the first prompt 504, and/or (iii) include one or more other prompt modification profiles in the set of matching prompt modification profiles 520 based upon a determination that the one or more other prompt modification profiles match the first prompt 504. In some examples, the content system may index the prompt modification profile database 514 (in at least one of a periodic manner, an aperiodic manner, a continuous manner, a discontinuous manner, etc., for example) for more efficient processing of the profile matching module 518 and/or to more enable faster identification of the set of matching prompt modification profiles 520 in response to the first prompt 504.

In some examples, the first prompt modification profile 526 may be generated based upon an automatic prompt modification request (e.g., a request to automatically modify at least some prompts received by the content system), which may be received from the first entity prior to receiving the first prompt 504. The content system may store the first prompt modification profile 526 in the prompt modification profile database 514 in response to the automatic prompt modification request. The first prompt modification profile 526 may comprise at least some information indicated by the automatic prompt modification request. The first entity may upload the automatic prompt modification request to the content system to modify prompts to updated prompts that result in content that promotes and/or advertises one or more products, one or more services, a brand, etc. associated with the first entity. For example, the automatic prompt modification request may be uploaded to the content system via an advertising service. The automatic prompt modification request may be associated with a campaign for promoting a brand, an image, a product and/or a service associated with the first entity. In some examples, the first entity provides compensation for events comprising at least one of impression events associated with the automatic prompt modification request (e.g., in an impression event, content generated based upon a prompt modified based upon the first prompt modification profile 526 is presented to a user by the content system), conversion events associated with the automatic prompt modification request (e.g., in a conversion event, content generated based upon a prompt modified based upon the first prompt modification profile 526 is presented to a user by the content system, and the user performs an action related to the content and/or the first entity after or while the content is presented, such as a purchase of a product, a subscription to a service, etc.), etc.

FIG. 5D illustrates an example of the first prompt modification profile 526. The first prompt modification profile 526 may comprise a prompt matching configuration 540, a prompt modification configuration 542, a bidding configuration 544 and/or a content configuration 545. The prompt matching configuration 540 may be used by the content system to determine whether a prompt matches the first prompt modification profile 526. For example, the prompt matching configuration 540 may comprise a program comprising instructions that when executed perform operations that determine whether the first prompt 504 matches the first prompt modification profile 526. In some examples, the program may be obfuscated such that a matching method used by the program is not discoverable (by an entity different than the first entity, for example). Alternatively and/or additionally, the prompt matching configuration 540 may comprise a set of prompt keys (e.g., a set of one or more prompt keys). For example, the set of prompt keys may comprise at least one of a first prompt key “Homemade Cookies Recipe”, a second prompt key “Recipe for Cookies”, a third prompt key “Dessert Recipe”, a fourth prompt key “Cookies”, etc.

In some examples, the content system may determine that the first prompt 504 matches the first prompt modification profile 526 based upon a determination that the first prompt 504 is equal to (e.g., the same as) a key of the set of prompt keys (such as when the first prompt 504 is “Homemade Cookies Recipe” equal to the first prompt key). Alternatively and/or additionally, the content system may determine that the first prompt 504 matches the first prompt modification profile 526 based upon a determination that at least a portion of the first prompt 504 is equal to (e.g., the same as) a key of the set of prompt keys (such as when the first prompt 504 comprises “Provide a recipe for baking homemade cookies”, a portion of which is equal to the fourth prompt key “cookies”). Alternatively and/or additionally, the content system may determine whether the first prompt 504 matches the first prompt modification profile 526 by (i) performing one or more text analysis operations (e.g., at least one of cosine similarity, bags of words, word-to-vector mapping, etc.) to determine a first similarity score associated with a similarity between the first prompt 504 and a prompt key of the set of prompt keys, and/or (ii) compare the first similarity score with a first threshold similarity score. For example, the content system may determine that the first prompt 504 matches the first prompt modification profile 526 based upon the first similarity score meeting (e.g., exceeding) the first threshold similarity score. Alternatively and/or additionally, the content system may determine, based upon one or more similarity scores (comprising the first similarity score), a first matching score associated with a relevance of the first prompt 504 to the first prompt modification profile 526 (e.g., how relevant the first prompt 504 is to the first prompt modification profile 526 and/or how well the first prompt 504 matches the first prompt modification profile 526). The one or more similarity scores may comprise similarity scores associated with similarities between the first prompt 504 and prompt keys of the set of prompt keys. In some examples, the content system may determine that the first prompt 504 matches the first prompt modification profile 526 based upon the first matching score meeting (e.g., exceeding) a first threshold matching score. Alternatively and/or additionally, the set of prompt keys may comprise one or more regular expressions that may be representative of one or more text patterns. For example, the one or more regular expressions may comprise a first regular expression “\d{3}[\s.−]?\d{4}”, which may be representative of local phone numbers (e.g., 3 digits, which may or may not be followed by a space or dash, and may be followed by 4 digits, where Id represents a digit). In an example, the content system may determine that the first prompt 504 matches the first prompt modification profile 526 based upon a determination that the first prompt 504 comprises text matching a text pattern of a regular expression of the set of prompt keys (e.g., the first prompt 504 comprises a local phone number corresponding to the text pattern indicated by the first regular expression).

In some examples, the content system may determine whether other prompt modification profiles (other than the first prompt modification profile 526) match the first prompt 504 using one or more of the techniques provided herein with respect to determining whether the first prompt modification profile 526 matches the first prompt 504.

In some examples, the set of matching prompt modification profiles 520 may be submitted to an allocation module 522. The allocation module 522 may select a set of selected profiles 524 (e.g., a set of one or more selected profiles) from the set of matching prompt modification profiles 520. The set of selected profiles 524 may be selected for use in modifying the first prompt 504 to generate an updated prompt to be submitted to the generative AI tool. In an example shown in FIG. 5C, the set of selected profiles 524 may comprise merely a single profile (e.g., the first prompt modification profile 526). Embodiments are contemplated in which the set of selected profiles 524 comprises more than one prompt modification profile, and/or in which the first prompt 504 is modified based upon more than one prompt modification profile to generate the updated prompt to be submitted to the generative AI tool (such as using one or more of the techniques provided below with respect to modifying the first prompt 504 based upon the first prompt modification profile 526 to generate an updated prompt 548 shown in FIG. 5D).

In some examples, the allocation module 522 may select the set of selected profiles 524 based upon a set of profile scores associated with the set of matching prompt modification profiles 520. For example, the set of profile scores may comprise a first profile score associated with the first prompt modification profile 526, a second profile score associated with the fourth prompt modification profile 532, and/or other profile scores associated with other prompt modification profiles of the set of matching prompt modification profiles 520.

The first profile score may be determined based upon (i) the first matching score associated with the first prompt modification profile 526 (ii) a first bid associated with the first prompt modification profile 526, (iii) a first predicted user experience impact associated with modifying the first prompt 504 based upon the first prompt modification profile 526, (iv) a first user response score associated with the first prompt modification profile 526, and/or (v) other information associated with the first prompt modification profile 526.

In some examples, the content system determines the first bid based upon the bidding configuration 544 (shown in FIG. 5D) of the first prompt modification profile 526. For example, the bidding configuration 544 may comprise a program comprising instructions that when executed perform operations that determine the first bid. In some examples, the program may be obfuscated such that a bidding method used by the program is not discoverable (by an entity different than the first entity, for example). Alternatively and/or additionally, the bidding configuration 544 may comprise an indication of the first bid (e.g., $1.50) submitted by the first entity.

In some examples, the first predicted user experience impact may correspond to a positive value (and/or the content system may increase the first profile score based upon the first predicted user experience impact) based upon a determination that modifying the first prompt 504 based upon the first prompt modification profile 526 would result in an improved user experience of the first user, which may be determined based upon the first user profile and/or the first prompt modification profile 526 (e.g., the content system may determine that modifying the first prompt 504 based upon the first prompt modification profile 526 would result in an improved user experience based upon a determination that one or more user interests indicated by the first user profile match one or more topics indicated by the first prompt modification profile 526). Alternatively and/or additionally, the first predicted user experience impact may correspond to a negative value (and/or the content system may reduce the first profile score based upon the first predicted user experience impact) based upon a determination that modifying the first prompt 504 based upon the first prompt modification profile 526 would result in a worsened user experience of the first user, which may be determined based upon the first user profile and/or the first prompt modification profile 526.

In some examples, the content system comprises a response prediction system configured to determine the first predicted user experience impact and/or the first user response score. In some examples, the response prediction system may comprise a first machine learning model. The response prediction system may use the first machine learning model to determine the first predicted user experience impact and/or the first user response score. In some examples, the first user response score may be based upon (and/or equal to) a probability of a user response event (e.g., an impression event, a conversion event, etc.) associated with the first entity occurring in response to content generated based upon a prompt that is modified according to the first prompt modification profile 526 being provided to the first user and/or the first client device 500. The response prediction system may determine the first user response score based upon the first user profile, historical user activity data (e.g., historical response data indicative of various content items provided to one or more users that resulted in one or more types of response events), and/or other data. For example, the first machine learning model may be trained (using the historical user activity data, for example) to select a prompt modification profile that has a higher probability of resulting in generation of content that is of interest to the first user. In some examples, the user response event may correspond to an event that the first bid is contingent upon. For example, the user response event may be a conversion event (and/or the first user response score may correspond to a conversion probability) when the first bid is associated with a conversion event requirement that requires that a conversion event to occur for an amount of compensation corresponding to the first bid to be due. In some examples, the first user response score may be combined with the first bid (and/or one or more other values such as the first matching score and/or the first predicted user experience impact) to determine a first expected value of modifying the first prompt 504 according to the first prompt modification profile 526. In some examples, the first expected value is based upon (and/or equal to) a product of the first user response score and the first bid. In some examples, the first profile score may be based upon (and/or equal to) the first expected value.

In some examples, the first profile score may be determined based upon an explore-exploit bonus associated with a value of modifying the first prompt 504 based upon the first prompt modification profile 526 for generating data (e.g., response data) to use as feedback to update and/or train the response prediction system and/or the first machine learning model. In some examples, the first profile score may be determined based upon a penalty associated with an uncertainty of the first user response score. For example, the first profile score may be reduced based upon a determination that the first user response score is associated with a confidence score that is less than a threshold confidence score.

In some examples, the content system may determine other profile scores of the set of profile scores (other than the first profile score) using one or more of the techniques provided herein with respect to determining the first profile score.

In some examples, the set of selected profiles 524 may be selected from among the set of matching prompt modification profiles 520 based upon the set of profile scores. In some examples, the set of selected profiles 524 may be selected from among the set of matching prompt modification profiles 520 based upon a determination that the set of selected profiles 524 are associated with highest profile scores of the set of profile scores. In an example, the set of selected profiles 524 may be selected from among the set of matching prompt modification profiles 520 based upon a determination that the set of selected profiles 524 are associated with n highest profile scores of the set of profile scores (e.g., profiles associated with the n highest profile scores of the set of profile scores may be included in the set of selected profiles 524). In an example where n is 2, 2 profiles associated with the 2 highest profile scores of the set of profile scores may be selected and/or included in the set of selected profiles 524. In an example where n is 1, a single profile (e.g., the first prompt modification profile 526) associated with the highest profile score of the set of profile scores may be selected and/or included in the set of selected profiles 524. Alternatively and/or additionally, the set of matching prompt modification profiles 520 may be ranked based upon the set of profile scores (e.g., a profile having a higher profile score is ranked higher than a profile having a lower profile score), and/or the top n ranked profiles may be selected from among the set of matching prompt modification profiles 520 (e.g., the top n ranked profiles may be included in the set of selected profiles 524). Alternatively and/or additionally, the set of selected profiles 524 may be selected from among the set of matching prompt modification profiles 520 based upon a determination that the set of selected profiles 524 are associated with profile scores (of the set of profile scores) that exceed a first threshold profile score.

In some examples, the allocation module 522 runs a first auction to select the set of selected profiles 524 from among the set of matching prompt modification profiles 520 (e.g., the set of matching prompt modification profiles 520 may be participants of the first auction). The first prompt modification profile 526 (and/or one or more other profiles selected by the allocation module 522) may correspond to a winner of the first auction. In some examples, the allocation module 522 may determine an amount of compensation associated with the winner of the first auction (e.g., an amount of compensation to charge the first entity for modifying the first prompt 504 according to the first prompt modification profile 526). In some examples, the amount of compensation may be determined based upon a type of auction of the first auction.

In some examples, the first auction and/or the first entity may be associated with a first bid floor (e.g., a reserve price). The first bid floor may correspond to a minimum bid required to participate in the first auction (e.g., the first bid may be set to a value that is at least the first bid floor such that the first prompt modification profile 526 is allowed to participate in the first auction). Alternatively and/or additionally, the amount of compensation may be based upon and/or equal to a maximum of (i) the first bid floor and (ii) the first bid.

In some examples, the first auction may be a first-price auction in which the amount of compensation is based upon and/or equal to the first bid (e.g., winning bid and/or highest bid participating in the first auction). Alternatively and/or additionally, the first auction may be a second-price auction in which the amount of compensation is based upon and/or equal to a second-highest bid of the first auction. Alternatively and/or additionally, the amount of compensation may be based upon and/or equal to a maximum of (i) the first bid floor and (ii) the second-highest bid of the first auction.

In some examples, the allocation module 522 may perform quasi-proportional allocation based upon the set of profile scores and/or a set of bids associated with the set of matching prompt modification profiles 520. For example, the allocation module 522 may (i) assign a first allocation share to the first prompt modification profile 526 based upon the first profile score and/or the first bid, (ii) assign a second allocation share to the fourth prompt modification profile 532 of the set of matching prompt modification profiles 520 based upon the second profile score and/or a second bid associated with the fourth prompt modification profile 532, and/or (iii) assign one or more other allocation shares to one or more other prompt modification profiles of the set of matching prompt modification profiles 520. In an example, the allocation module 522 may perform one or more operations (e.g., mathematical operations) using the first profile score, the first bid, a combination profile score (e.g., a sum of the set of profile scores) and/or a combination bid (e.g., a sum of the set of bids) to determine the first allocation share. In an example, the allocation module 522 may divide the first bid by the combination bid to determine the first allocation share. In an example, the allocation module 522 may divide the first profile score by the combination profile score to determine the first allocation share.

In some examples, among prompts (e.g., the first prompt 504 from the first user and/or other prompts from the first user and/or other users) received by the content system that are determined to match the first prompt modification profile 526, the allocation module 522 may modify a first subset of the prompts according to the first prompt modification profile 526 to generate updated prompts associated with the first entity for submission to the generative AI tool, wherein the first subset amounts to the first allocation share. Alternatively and/or additionally, among prompts (e.g., the first prompt 504 from the first user and/or other prompts from the first user and/or other users) received by the content system that are determined to match the fourth prompt modification profile 532, the allocation module 522 may modify a second subset of the prompts according to the fourth prompt modification profile 532 to generate updated prompts associated with the fourth entity for submission to the generative AI tool, wherein the second subset amounts to the second allocation share.

Alternatively and/or additionally, the allocation module 522 may select the set of selected profiles 524 according to probabilities determined based upon allocation shares assigned to prompt modification profiles. For example, the allocation module 522 may assign a first probability (e.g., 50%) to the first prompt modification profile 526 based upon the first allocation share (e.g., 0.5) and/or a second probability (e.g., 30%) to the fourth prompt modification profile 532 based upon the second allocation share (e.g., 0.3). The first probability may correspond to a probability that the first prompt modification profile 526 is selected for use in modifying the first prompt 504 (e.g., a probability that the first prompt modification profile 526 is included in the set of selected profiles 524). The second probability may correspond to a probability that the fourth prompt modification profile 532 is selected for use in modifying the first prompt 504 (e.g., a probability that the fourth prompt modification profile 532 is included in the set of selected profiles 524). Selecting (via random selection, for example) a prompt modification profile for use in modifying the first prompt 504 based upon the probabilities may introduce randomness in modifying the first prompt 504, which may improve user experience and/or may be a good fit for the content system since the generative AI tool may (also) have randomness in its content creation.

In some examples, performing quasi-proportional allocation provides for increased variety and/or randomness of content provided to users of the content system (such as due, at least in part, to increasing a variety and/or randomness of profiles used to modify incoming prompts from the users), which may provide for an improved user experience.

At 406 of FIG. 4, the content system may modify the first prompt 504, based upon the first prompt modification profile 526, to generate the updated prompt 548. For example, the first prompt 504 may be modified according to the first prompt modification profile 526 in response to the allocation module 522 selecting the first prompt modification profile 526 (and/or the first prompt modification profile 526 winning the first auction). The prompt modification configuration 542 may be used by the content system to modify the first prompt 504 to generate the updated prompt.

For example, the prompt modification configuration 542 may comprise a program comprising instructions that when executed perform operations that modify the first prompt 504 to the updated prompt. In some examples, the program may be obfuscated such that a prompt modification method used by the program is not discoverable (by an entity different than the first entity, for example). Alternatively and/or additionally, the prompt modification configuration 542 may comprise a supplemental set of text (and/or an instruction to add the supplemental set of text to the first prompt 504). In an example, the supplemental set of text may comprise “and make the car a V6 Fastrunner” to add to the first prompt 504 (when the first prompt 504 comprises “Provide a story about a fast car”, for example), which may result in providing information, to the first user, about a car model “V6 Fastrunner” (e.g., the first entity may be a car company that wants to promote the car model). Alternatively and/or additionally, the supplemental set of text may comprise “and mention GreatProduct Chocolate Chip Cookies” to add to the first prompt 504 (when the first prompt 504 comprises “Provide a recipe for baking homemade cookies”, for example), which may result in providing information, to the first user, about a food product by a brand “GreatProduct” (e.g., the first entity may be the brand “GreatProduct”). In some examples, the updated prompt may be generated by merely supplementing the first prompt 504 with the supplemental set of text. Alternatively and/or additionally, the updated prompt may be generated by (i) removing at least a portion of the first prompt 504 and/or (ii) supplementing the first prompt 504 with the supplemental set of text (e.g., replacing one or more portions of the first prompt 504 with one or more sets of text and/or one or more words at the beginning of the first prompt 504, at the end of the first prompt 504 and/or between the beginning and the end of the first prompt 504). Alternatively and/or additionally, the updated prompt may be generate by rewriting (e.g., completely rewriting) at least a portion the first prompt 504 (based upon the prompt modification configuration 542, for example).

FIG. 5D illustrates a prompt modification module 546 generating the updated prompt 548. For example, the prompt modification module 546 may retrieve the prompt modification configuration 542 from the first prompt modification profile 526, and/or may use the prompt modification configuration 542 to apply one or more modifications to the first prompt 504 to generate the updated prompt 548. In the example shown in FIG. 5D, the prompt modification module 546 may supplement the first prompt 504 with a set of text “and mention GreatProduct Chocolate Chip Cookies” to generate the updated prompt 548.

In some examples, the updated prompt 548 may be generated via multiple iterations of modifications. In an example, the first prompt 504 may be modified according to the first prompt modification profile 526 to generate an initial updated prompt. One or more acts may be performed (e.g., one or more of the acts shown in and/or discussed with respect to FIGS. 5C-5D) to (i) identify a second set of matching prompt modification profiles determined to match at least a portion of the initial updated prompt (using one or more of the techniques provided herein with respect to identifying the set of matching prompt modification profiles 520, for example), (ii) select a prompt modification profile from the second set of matching prompt modification profiles (using one or more of the techniques provided herein with respect to selecting the set of selected profiles 524, for example), and/or (iii) modify the initial updated prompt according to the prompt modification profile to generate the updated prompt 548 or a prompt that is further modified to generate the updated prompt 548.

At 408 of FIG. 4, the content system may generate, using the generative AI tool, a first content item based upon the updated prompt 548. FIG. 5E illustrates generation of the first content item (shown with reference number 556) based upon the updated prompt 548. For example, the updated prompt 548 may be submitted to the generative AI tool (shown with reference number 554), which may generate the first content item 556 based upon the updated prompt 548. The first content item 556 may comprise AI-generated content. The first content item 556 may comprise a set of text, an image, a video, audio, AR content, MR content, VR content, interactive content, dynamic content, and/or other type of content.

In some examples, the generative AI tool 554 comprises one or more machine learning models (e.g., generative machine learning models). In some examples, the one or more machine learning models may comprise a language model (e.g., a large language model (LLM)) (to generate text of the first content item 556, for example). In some examples, the one or more machine learning models may comprise one or more generative pre-trained transformer models. In some examples, the one or more machine learning models may comprise one or more image generation models (to generate an image of the first content item 556, for example). In some examples, the one or more machine learning models may comprise one or more audio generation models (to generate audio of the first content item 556, for example). In some examples, the one or more machine learning models may comprise one or more video generation models (to generate video of the first content item 556, for example).

In some examples, the generative AI tool 554 may comprise and/or may be trained using (i) one or more text generation resources (e.g., a knowledge base for generating text) to enable the generative AI tool 554 to generate text (e.g., the one or more text generation resources may comprise at least one of a corpus, such as a text corpus, one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.), (ii) one or more image generation resources (e.g., a knowledge base for generating images) to enable the generative AI tool 554 to generate images (e.g., the one or more image generation resources may comprise at least one of photographs, pictures, drawings, 3D renderings, etc.), (iii) one or more audio generation resources (e.g., a knowledge base for generating audio) to enable the generative AI tool 554 to generate audio (e.g., the one or more audio generation resources may comprise recordings of speech of various people which may allow the generative AI tool 554 to automatically generate audio depicting speech of a person, etc.), and/or (iv) other resources (e.g., video generation resources).

One, some and/or all machine learning models of the present disclosure (e.g., the one or more machine learning models of the generative AI tool 554 and/or the first machine learning model of the response prediction system) may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

FIG. 5F illustrates a representation of the first content item 556 generated by the generative AI tool 554 based upon the updated prompt 548. In the representation shown in FIG. 5F, the first content item 556 may be generated to comprise one or more indications of “GreatProduct chocolate chips” due to the updated prompt 548 comprising the supplemental set of text “and mention GreatProduct Chocolate Chip Cookies”. Thus, one or more of the techniques of the present disclosure may be used to introduce and/or amplify material about products, services, brands, etc. in content items generated using the generative AI tool 554.

In some examples, the first content item 556 may be modified to generate a second content item (e.g., an updated content item). For example, the first content item 556 may be modified based upon the content configuration 545 of the first prompt modification profile 526. In some examples, the content configuration 545 may be indicative of one or more modifications to perform to the first content item 556 to generate the second content item. In some examples, the content configuration 545 may comprise a program comprising instructions that when executed perform operations that modify the first content item 556 to generate the second content item. In some examples, the program may be obfuscated such that a prompt modification method used by the program is not discoverable (by an entity different than the first entity, for example).

Alternatively and/or additionally, the content configuration 545 may comprise an indication of one or more supplemental content items (e.g., at least one of a set of text, a hyperlink, a graphical object, an audio file, a video, an image, AR content, MR content, VR content, interactive content, dynamic content, an advertisement, etc.) to add to the first content item 556 to generate the second content item. Alternatively and/or additionally, the content configuration 545 may comprise an indication (e.g., a uniform resource locator (URL)) of a first internet resource (e.g., a web page) associated with the first entity. In some examples, the first content item 556 may be analyzed to identify a portion 555 (shown in FIG. 5F), of the first content item 556, relevant to the first entity associated with the first prompt modification profile 526. The portion 555 may be identified based upon a determination that the portion 555 comprises an indication of the first entity (e.g., GreatProduct) and/or an indication of at least one of a product, a service, etc. provided by the first entity (e.g., chocolate chips). The first content item 556 may be modified to generate the second content item based upon the portion 555 and/or the one or more supplemental content items. In an example, the portion 555 of the first content item 556 may be supplemented with a supplemental content item of the one or more supplemental content items to generate the second content item.

Alternatively and/or additionally, at least some of the portion 555 may be converted into the supplemental content item (such as a first hyperlink 560 shown in FIG. 5G). In some examples, the content configuration 545 may comprise an indication of one or more modifications to apply to one or more portions of the first content item 556 (such as the portion 555 and/or one or more other portions). The one or more modifications may comprise one or more formatting changes, such as at least one of underlining text of the first content item 556, increasing or decreasing a size of a set of text of the first content item 556, changing a font of a set of text of the first content item 556, changing a background color of a portion of the first content item 556, etc. In some examples, the content configuration 545 may comprise an indication of one or more locations at which to insert and/or include the one or more supplemental content items. In some examples, the one or more locations may include (i) a top and/or beginning of the first content item 556 (e.g., a supplemental content item may be inserted into a region comprising the top and/or beginning of the first content item 556), (ii) a bottom and/or end of the first content item 556 (e.g., a supplemental content item may be inserted into a region comprising the bottom and/or end of the first content item 556), (iii) a location that is adjacent to (and/or within a threshold distance of) the portion 555, (iv) an intermediate region between the beginning and the end of the first content item 556, and/or (v) one or more other locations.

FIG. 5G illustrates a representation of the second content item (shown with reference number 563). In the representation shown in FIG. 5G, the second content item 563 may be generated to include a first hyperlink 560 (e.g., a first supplemental content item of the one or more supplemental content items). In some examples, the first hyperlink 560 may be formatted (e.g., at least one of underlined, bolded, formatted with a different color than other text of the second content item 563, have a different font than other text of the second content item 563, etc.). In some examples, the first hyperlink 560 may point to the first internet resource (e.g., a webpage for purchasing a product from the first entity). For example, in response to a selection of the first hyperlink 560 on the first client device 500, the first client device 500 may be directed to the first internet resource associated with the first entity. For example, the first internet resource may be automatically displayed on the first client device 500 (via a browser, for example) in response to the selection of the first hyperlink 560.

At 410 of FIG. 4, the content system may identify a set of matching content modification profiles (e.g., set of one or more content modification profiles) matching at least a portion of the second content item 563. For example, the content system may access a content modification profile database comprising a plurality of content modification profiles to identify the set of matching content modification profiles, which of which is determined to match at least a portion of the second content item 563. The content modification profile database may be stored on one or more second data stores. In some examples, the plurality of content modification profiles may be associated with a second plurality of entities, which may be the same as or different than the first plurality of entities. An entity of the second plurality of entities may correspond to at least one of an advertiser, a campaign of an advertiser, a company, a sponsor, a brand, an organization, a source of information, a publisher, a content creator, etc. FIG. 5H illustrates a second profile matching module 568 used to identify the set of matching content modification profiles (shown with reference number 570). The content modification profile database (shown with reference number 564) may comprise at least one of a first content modification profile 576 associated with a fifth entity “Entity A” (e.g., a fifth advertiser, campaign, company, sponsor, brand, organization, source of information, publisher, and/or content creator), a second content modification profile 578 associated with a sixth entity “Entity B” (e.g., a sixth advertiser, campaign, company, sponsor, brand, organization, source of information, publisher, and/or content creator), a third content modification profile 580 associated with a seventh entity “Entity C”, a fourth content modification profile 582 associated with an eighth entity “Entity D”, etc.

The second profile matching module 568 may scan the content modification profiles of the content modification profile database 564 based upon the second content item 563 to identify the set of matching content modification profiles 570. For example, the second profile matching module 568 may compare the second content item 563 with the content modification profiles of the content modification profile database 564 to identify the set of matching content modification profiles 570. In some examples, the second profile matching module 568 may (i) include the first content modification profile 576 in the set of matching content modification profiles 570 based upon a determination that the first content modification profile 576 matches a first portion of the second content item 563, (ii) include the fourth content modification profile 582 in the set of matching content modification profiles 570 based upon a determination that the fourth content modification profile 582 matches a second portion of the second content item 563 (e.g., the second portion may be the same as or different than the first portion of the second content item 563), and/or (iii) include one or more other content modification profiles in the set of matching content modification profiles 570 based upon a determination that the one or more other content modification profiles match at least a portion of the second content item 563. In some examples, the content system may index the content modification profile database 564 (in at least one of a periodic manner, an aperiodic manner, a continuous manner, a discontinuous manner, etc., for example) for more efficient processing of the second profile matching module 568 and/or to more enable faster identification of the set of matching content modification profiles 570.

In some examples, the first content modification profile 576 may be generated based upon an automatic content modification request (e.g., a request to automatically modify at least some content items generated using the generative AI tool 554), which may be received from the fifth entity prior to receiving the second content item 563. The content system may store the first content modification profile 576 in the content modification profile database 564 in response to the automatic content modification request. The first content modification profile 576 may comprise at least some information indicated by the automatic content modification request. The fifth entity may upload the automatic content modification request to the content system to modify content items to updated content items that promote and/or advertise one or more products, one or more services, a brand, etc. associated with the fifth entity. For example, the automatic content modification request may be uploaded to the content system via an advertising service. The automatic content modification request may be associated with a campaign for promoting a brand, an image, a product and/or a service associated with the fifth entity. In some examples, the fifth entity provides compensation for events comprising at least one of impression events associated with the automatic content modification request (e.g., in an impression event, a content item generated based upon the first content modification profile 576 is presented to a user by the content system), conversion events associated with the automatic content modification request, etc.

FIG. 5I illustrates an example of the first content modification profile 576. The first content modification profile 576 may comprise a content matching configuration 590, a content modification configuration 592 and/or a second bidding configuration 594. The content matching configuration 590 may be used by the content system to determine whether a content item (and/or a portion of the content item) matches the first content modification profile 576. For example, the content matching configuration 590 may comprise a program comprising instructions that when executed perform operations that determine whether the second content item 563 comprises at least a portion (e.g., the first portion) matching the first content modification profile 576. In some examples, the program may be obfuscated such that a matching method used by the program is not discoverable (by an entity different than the fifth entity, for example). Alternatively and/or additionally, the content matching configuration 590 may comprise a set of content keys (e.g., a set of one or more content keys). For example, the set of content keys may comprise at least one of a first content key “Brown Sugar”, a second content key “Organic Sugar”, etc.

In some examples, the content system may determine that the first portion of the second content item 563 matches the first content modification profile 576 based upon a determination that at least some of the first portion of the second content item 563 is equal to (e.g., the same as) a key of the set of content keys (such as when the first portion of the second content item 563 comprises text “brown sugar” which may be determined to be equal to the first content key “Brown Sugar”). Alternatively and/or additionally, the content system may determine whether second content item 563 matches the first content modification profile 576 by (i) performing one or more text analysis operations (e.g., at least one of cosine similarity, bags of words, word-to-vector mapping, etc.) to determine a second similarity score associated with a similarity between the first portion of the second content item 563 and a content key of the set of content keys, and/or (ii) compare the second similarity score with a second threshold similarity score. For example, the content system may determine that the second content item 563 matches the first content modification profile 576 based upon the second similarity score meeting (e.g., exceeding) the second threshold similarity score. Alternatively and/or additionally, the content system may determine, based upon one or more similarity scores (comprising the second similarity score), a second matching score associated with a relevance of the second content item 563 to the first content modification profile 576 (e.g., how relevant the first portion of the second content item 563 is to the first content modification profile 576 and/or how well the first portion of the second content item 563 matches the first content modification profile 576). The one or more similarity scores may comprise similarity scores associated with similarities between the second content item 563 and content keys of the set of content keys. In some examples, the content system may determine that the second content item 563 matches the first content modification profile 576 based upon the second matching score meeting (e.g., exceeding) a second threshold matching score. Alternatively and/or additionally, the set of content keys may comprise one or more regular expressions that may be representative of one or more text patterns. In an example, the content system may determine that the first portion of the second content item 563 matches the first content modification profile 576 based upon a determination that the first portion of the second content item 563 comprises text matching a text pattern of a regular expression of the set of content keys.

In some examples, the content system may determine whether other content modification profiles (other than the first content modification profile 576) match the second content item 563 using one or more of the techniques provided herein with respect to determining whether the first content modification profile 576 matches the second content item 563.

In some examples, the set of matching content modification profiles 570 may be submitted to a second allocation module 572. The second allocation module 572 may select a second set of selected profiles 574 (e.g., a set of one or more selected profiles) from the set of matching content modification profiles 570. The second set of selected profiles 574 may be selected for use in modifying the second content item 563 to generate an updated content item for transmission to the first client device 500. In an example shown in FIG. 5I, the second set of selected profiles 574 may comprise merely a single profile (e.g., the first content modification profile 576). Embodiments are contemplated in which the second set of selected profiles 574 comprises more than one content modification profile, and/or in which the second content item 563 is modified based upon more than one content modification profile to generate the updated content item to be transmitted to the first client device 500 (such as using one or more of the techniques provided below with respect to modifying the second content item 563 based upon the first content modification profile 576 to generate an updated content item 598 shown in FIG. 5J). In an example, in order to generate the updated content item for transmission to the first client device 500, the content system may perform (i) a first modification to the second content item 563 based upon the first portion and/or the first content modification profile 576 (e.g., the content system may supplement the first portion of the second content item 563 with a link to a second internet resource associated with the fifth entity) and/or (ii) a second modification to the second content item 563 based upon the second portion and/or the fourth content modification profile 582 (e.g., the content system may supplement the second portion of the second content item 563 with a link to an internet resource associated with the eighth entity).

In some examples, the second allocation module 572 may select the second set of selected profiles 574 based upon a second set of profile scores associated with the set of matching content modification profiles 570. For example, the second set of profile scores may comprise a third profile score associated with the first content modification profile 576, a fourth profile score associated with the fourth content modification profile 582, and/or other profile scores associated with other content modification profiles of the set of matching content modification profiles 570.

The third profile score may be determined based upon (i) the second matching score associated with the first content modification profile 576 (ii) a third bid associated with the first content modification profile 576, (iii) a third predicted user experience impact associated with modifying the second content item 563 based upon the first content modification profile 576 (iv) a third user response score associated with the first content modification profile 576, and/or (v) other information associated with the first content modification profile 576. For example, the content system may perform one or more operations (e.g., mathematical operations) using the second matching score, the third bid associated with the first content modification profile 576, the third predicted user experience impact, and/or the third user response score to determine the third profile score.

In some examples, the content system determines the third bid based upon the second bidding configuration 594 (shown in FIG. 5I) of the first content modification profile 576. For example, the second bidding configuration 594 may comprise a program comprising instructions that when executed perform operations that determine the third bid. In some examples, the program may be obfuscated such that a bidding method used by the program is not discoverable (by an entity different than the fifth entity, for example). Alternatively and/or additionally, the second bidding configuration 594 may comprise an indication of the third bid (e.g., $2.60) submitted by the fifth entity.

In some examples, the third predicted user experience impact may correspond to a positive value (and/or the content system may increase the third profile score based upon the third predicted user experience impact) based upon a determination that modifying the second content item 563 based upon the first content modification profile 576 would result in an improved user experience of the first user, which may be determined based upon the first user profile and/or the first content modification profile 576 (e.g., the content system may determine that modifying the second content item 563 based upon the first content modification profile 576 would result in an improved user experience based upon a determination that one or more user interests indicated by the first user profile match one or more topics indicated by the first content modification profile 576). Alternatively and/or additionally, the third predicted user experience impact may correspond to a negative value (and/or the content system may reduce the third profile score based upon the third predicted user experience impact) based upon a determination that modifying the second content item 563 based upon the first content modification profile 576 would result in a worsened user experience of the first user, which may be determined based upon the first user profile and/or the first content modification profile 576.

In some examples, the response prediction system (and/or the first machine learning model) may be used to determine the third predicted user experience impact and/or the third user response score. In some examples, the third user response score may be based upon (and/or equal to) a probability of a user response event (e.g., an impression event, a conversion event, etc.) associated with the fifth entity occurring in response to content modified according to the first content modification profile 576 being provided to the first user and/or the first client device 500. The response prediction system may determine the third user response score based upon the first user profile, historical user activity data, and/or other data. In some examples, the user response event may correspond to an event that the third bid is contingent upon. In some examples, the third user response score may be combined with the third bid (and/or one or more other values such as the first matching score and/or the third predicted user experience impact) to determine a second expected value of using the first content modification profile 576 to update content (to generate the updated content item 598, for example) for transmission to the first user and/or the first client device 500. In some examples, the third expected value is based upon (and/or equal to) a product of the third user response score and the third bid. In some examples, the third profile score may be based upon (and/or equal to) the third expected value.

In some examples, the third profile score may be determined based upon an explore-exploit bonus associated with a value of using the first content modification profile 576 to update content for generating data (e.g., response data) to use as feedback to update and/or train the response prediction system and/or the first machine learning model. In some examples, the third profile score may be determined based upon a penalty associated with an uncertainty of the third user response score. For example, the third profile score may be reduced based upon a determination that the third user response score is associated with a confidence score that is less than a threshold confidence score.

In some examples, the content system may determine other profile scores of the second set of profile scores (other than the third profile score) using one or more of the techniques provided herein with respect to determining the third profile score.

In some examples, the second set of selected profiles 574 may be selected from among the set of matching content modification profiles 570 based upon the second set of profile scores. In some examples, the second set of selected profiles 574 may be selected from among the set of matching content modification profiles 570 based upon a determination that the second set of selected profiles 574 are associated with highest profile scores of the second set of profile scores. In an example, the second set of selected profiles 574 may be selected from among the set of matching content modification profiles 570 based upon a determination that the second set of selected profiles 574 are associated with m highest profile scores of the second set of profile scores (e.g., profiles associated with the m highest profile scores of the second set of profile scores may be included in the second set of selected profiles 574). In an example where m is 2, 2 profiles associated with the 2 highest profile scores of the second set of profile scores may be selected and/or included in the second set of selected profiles 574. In an example where m is 1, a single profile (e.g., the first content modification profile 576) associated with the highest profile score of the second set of profile scores may be selected and/or included in the second set of selected profiles 574. Alternatively and/or additionally, the set of matching content modification profiles 570 may be ranked based upon the second set of profile scores (e.g., a profile having a higher profile score is ranked higher than a profile having a lower profile score), and/or the top m ranked profiles may be selected from among the set of matching content modification profiles 570 (e.g., the top m ranked profiles may be included in the second set of selected profiles 574). Alternatively and/or additionally, the second set of selected profiles 574 may be selected from among the set of matching content modification profiles 570 based upon a determination that the second set of selected profiles 574 are associated with profile scores (of the second set of profile scores) that exceed a second threshold profile score.

In some examples, the second allocation module 572 runs a second auction to select the second set of selected profiles 574 from among the set of matching content modification profiles 570 (e.g., the set of matching content modification profiles 570 may be participants of the second auction). The first content modification profile 576 (and/or one or more other profiles selected by the second allocation module 572) may correspond to a winner of the second auction. In some examples, the second allocation module 572 may determine a second amount of compensation associated with the winner of the second auction (e.g., an amount of compensation to charge the fifth entity for modifying the second content item 563 according to the first content modification profile 576). In some examples, the second amount of compensation may be determined based upon a type of auction of the second auction.

In some examples, the second auction and/or the fifth entity may be associated with a third bid floor (e.g., a reserve price). The third bid floor may correspond to a minimum bid required to participate in the second auction (e.g., the third bid may be set to a value that is at least the third bid floor such that the first content modification profile 576 is allowed to participate in the second auction). Alternatively and/or additionally, the second amount of compensation may be based upon and/or equal to a maximum of (i) the third bid floor and (ii) the third bid.

In some examples, the second auction may be a first-price auction in which the second amount of compensation is based upon and/or equal to the third bid (e.g., winning bid and/or highest bid participating in the second auction). Alternatively and/or additionally, the second auction may be a second-price auction in which the second amount of compensation is based upon and/or equal to a second-highest bid of the second auction. Alternatively and/or additionally, the second amount of compensation may be based upon and/or equal to a maximum of (i) the third bid floor and (ii) the second-highest bid of the second auction.

In some examples, the second allocation module 572 may perform quasi-proportional allocation based upon the second set of profile scores and/or a set of bids associated with the set of matching content modification profiles 570. For example, the second allocation module 572 may (i) assign a third allocation share to the first content modification profile 576 based upon the third profile score and/or the third bid, (ii) assign a fourth allocation share to the fourth content modification profile 582 of the set of matching content modification profiles 570 based upon the fourth profile score and/or a fourth bid associated with the fourth content modification profile 582, and/or (iii) assign one or more other allocation shares to one or more other content modification profiles of the set of matching content modification profiles 570. In an example, the second allocation module 572 may perform one or more operations (e.g., mathematical operations) using the third profile score, the third bid, a second combination profile score (e.g., a sum of the second set of profile scores) and/or a second combination bid (e.g., a sum of the set of bids) to determine the third allocation share. In an example, the second allocation module 572 may divide the third bid by the second combination bid to determine the third allocation share. In an example, the second allocation module 572 may divide the third profile score by the second combination profile score to determine the third allocation share.

In some examples, among content items (e.g., the second content item 563 and/or other content items) generated using the generative AI tool 554 that are determined to match the first content modification profile 576, the second allocation module 572 may modify a third subset of the content items according to the first content modification profile 576 to generate updated content items associated with the fifth entity for transmission to client devices, wherein the third subset amounts to the third allocation share. Alternatively and/or additionally, among content items (e.g., the second content item 563 and/or other content items) generated using the generative AI tool 554 that are determined to match the fourth content modification profile 582, the second allocation module 572 may modify a fourth subset of the content items according to the fourth content modification profile 582 to generate updated content items associated with the eighth entity for submission to the generative AI tool 554, wherein the fourth subset amounts to the fourth allocation share.

Alternatively and/or additionally, the second allocation module 572 may select the second set of selected profiles 574 according to probabilities determined based upon allocation shares assigned to content modification profiles. For example, the second allocation module 572 may assign a third probability (e.g., 50%) to the first content modification profile 576 based upon the third allocation share (e.g., 0.5) and/or a fourth probability (e.g., 30%) to the fourth content modification profile 582 based upon the fourth allocation share (e.g., 0.3). The third probability may correspond to a probability that the first content modification profile 576 is selected for use in modifying the second content item 563 (e.g., a probability that the first content modification profile 576 is included in the second set of selected profiles 574). The fourth probability may correspond to a probability that the fourth content modification profile 582 is selected for use in modifying the second content item 563 (e.g., a probability that the fourth content modification profile 582 is included in the second set of selected profiles 574). Selecting (via random selection, for example) a content modification profile for use in modifying the second content item 563 based upon the probabilities may introduce randomness in modifying the second content item 563, which may improve user experience and/or may be a good fit for the content system since the generative AI tool 554 may (also) have randomness in its content creation.

In some examples, performing quasi-proportional allocation provides for increased variety and/or randomness of content provided to users of the content system (such as due, at least in part, to increasing a variety and/or randomness of profiles used to modify content items to transmit to users), which may provide for an improved user experience.

At 412 of FIG. 4, the content system may modify the second content item 563, based upon the first content modification profile 576, to generate the updated content item 598. For example, the second content item 563 may be modified according to the first content modification profile 576 in response to the second allocation module 572 selecting the first content modification profile 576 (and/or the first content modification profile 576 winning the second auction). The content modification configuration 592 may be used by the content system to modify the second content item 563 to generate the updated content item 598.

FIG. 5I illustrates a content modification module 596 generating the updated content item 598. For example, the content modification module 596 may retrieve the content modification configuration 592 from the first content modification profile 576, and/or may use the content modification configuration 592 to apply one or more modifications to the second content item 563 to generate the updated content item 598. In the example shown in FIG. 5I, the content modification configuration 592 may comprise an instruction to supplement the second content item 563 with a graphical object (e.g., a purchase button) pointing to a URL of a purchasing web page associated with the fifth entity (e.g., a webpage for purchasing organic brown sugar).

In some examples, the content modification configuration 592 may comprise a program comprising instructions that when executed perform operations that modify the second content item 563 to generate the updated content item 598. In some examples, the program may be obfuscated such that a prompt modification method used by the program is not discoverable (by an entity different than the first entity, for example). Alternatively and/or additionally, the content modification configuration 592 may comprise an indication of one or more second supplemental content items (e.g., at least one of a set of text, a hyperlink, a graphical object, an audio file, an advertisement, etc.) to add to the second content item 563 to generate the updated content item 598. Alternatively and/or additionally, the content modification configuration 592 may comprise an indication (e.g., a URL) of the second internet resource (e.g., a web page) associated with the fifth entity. The second content item 563 may be modified to generate the updated content item 598 based upon the first portion (e.g., portion 597 in FIG. 5J) of the second content item 563 and/or the one or more second supplemental content items. In an example, a region of the second content item 563 comprising the first portion of the second content item 563 may be supplemented with a supplemental content item of the one or more second supplemental content items to generate the updated content item 598. Alternatively and/or additionally, at least some of the first portion may be converted into the supplemental content item (such as a hyperlink). In some examples, the content modification configuration 592 may comprise an indication of one or more modifications to apply to one or more portions of the second content item 563 (such as the first portion and/or one or more other portions). The one or more modifications may comprise one or more formatting changes, such as at least one of underlining text of the second content item 563, increasing or decreasing a size of a set of text of the second content item 563, changing a font of a set of text of the second content item 563, changing a background color of a portion of the second content item 563, etc. In some examples, the content modification configuration 592 may comprise an indication of one or more locations at which to insert and/or include the one or more second supplemental content items. In some examples, the one or more locations may include (i) a top and/or beginning of the second content item 563 (e.g., a supplemental content item may be inserted into a region comprising the top and/or beginning of the second content item 563), (ii) a bottom and/or end of the second content item 563 (e.g., a supplemental content item may be inserted into a region comprising the bottom and/or end of the second content item 563), (iii) a location that is adjacent to (and/or within a threshold distance of) the first portion, (iv) an intermediate region between the beginning and the end of the second content item 563, and/or (v) one or more other locations.

FIG. 5J illustrates a representation of the updated content item 598. In the representation shown in FIG. 5J, the updated content item 598 may be generated to include a purchase button 599, which may be displayed adjacent to the first portion (e.g., a reference to “brown sugar” with reference number 597 in FIG. 5J) of the second content item 563. In some examples, the purchase button 599 may comprise at least one of text, one or more images, etc. In some examples, the purchase button 599 may point to the second internet resource (e.g., a webpage for purchasing a product from the fifth entity). For example, in response to a selection of the purchase button 599 on the first client device 500, the first client device 500 may be directed to the second internet resource associated with the fifth entity. For example, the second internet resource may be automatically displayed on the first client device 500 (via a browser, for example) in response to the selection of the purchase button 599.

At 414 of FIG. 4, the content system may provide the updated content item 598 for presentation on the first client device 500. For example, the updated content item 598 may be presented by the content interface 506. In some examples, the updated content item 598 may be displayed as a response message responsive to the first prompt 504 (e.g., the updated content item 598 may be displayed as part of the conversation between the first user and the generative AI tool 554). In some examples, the content system may monitor for one or more user response events associated with the first user and/or the updated content item 598. For example, a billing system of the content system may (i) bill the first entity the amount of compensation in response to identifying a user response event associated with the first entity (e.g., a selection of the first hyperlink 560, a conversion event in which the first user purchases a product, such as chocolate chips, from the first entity) and/or (ii) bill the fifth entity the second amount of compensation in response to identifying a user response event associated with the fifth entity (e.g., a selection of the purchase button 599, a conversion event in which the first user purchases a product, such as sugar, from the fifth entity). The billing system may be used to assess and/or communicate charges and/or collect payments. In some examples, a bid may be contingent upon successful product placement and/or mention of service being included in a content item sent to a user. For example, the first bid may be contingent upon the first content item 556, the second content item 563 and/or the updated content item 598 being provided to and/or presented on the first client device 500. Thus, the billing system may bill the first entity in response to determining that the first content item 556, the second content item 563 and/or the updated content item 598 are provided to and/or presented on the first client device 500. Alternatively and/or additionally, a bid may be contingent on user data, including previous prompts from the first user and/or content items the first user has experienced, which may be in the same conversation between the first user and the generative AI tool 554.

Although one or more of the examples herein are provided with respect to embodiments in which the profile matching module 518 and/or the second profile matching module 568 perform text-to-text matching (for text-based content items, for example), embodiments are contemplated in which the profile matching module 518 and/or the second profile matching module 568 perform image-to-image mapping and/or video-to-video matching. Alternatively and/or additionally, the profile matching module 518 and/or the second profile matching module 568 may perform cross-media mapping.

In an example, the second content item 563 may comprise a video (e.g., an AI-generated video generated using the generative AI tool 554 554). The second profile matching module 568 may generate text representative of at least a portion of the video. The text may comprise (i) a transcript of audio of the video (generated using one or more audio-to-text conversion tools, for example), (ii) a description of one or more actions that occur in the video, and/or (iii) a description of one or more visual objects identified in the video. The second profile matching module 568 may match one or more portions of the text to one or more keys (e.g., text-based keys) of the set of content keys indicated by the content matching configuration 590 to determine that the first content modification profile 576 matches at least a portion of the second content item 563 (and thereby include the first content modification profile 576 in the set of matching content modification profiles 570, for example). Alternatively and/or additionally, the second profile matching module 568 may match at least a portion of one or more video frames of the video to one or more image keys of the set of content keys to determine that the first content modification profile 576 matches at least a portion of the second content item 563 (and thereby include the first content modification profile 576 in the set of matching content modification profiles 570, for example). In some examples, the video may be modified by the content modification module 596 to generate the updated content item 598, which may comprise an updated video. For example, at least a portion of the video (e.g., a portion of the video that corresponds to a portion of the text that matches a key of the set of content keys) may be supplemented with the one or more second supplemental content items, which may comprise at least one of (i) one or more visual objects added to one or more video frames of the video, (ii) a selectable button pointing to the second internet resource, (iii) video content generated using the generative AI tool 554, (iv) audio and/or (v) one or more other content items.

In an example, the second content item 563 may comprise an image (e.g., an AI-generated image generated using the generative AI tool 554). The second profile matching module 568 may generate text representative of at least a portion of the image. The text may comprise a description of one or more visual objects identified in the image. The second profile matching module 568 may match one or more portions of the text to one or more keys (e.g., text-based keys) of the set of content keys indicated by the content matching configuration 590 to determine that the first content modification profile 576 matches at least a portion of the second content item 563 (and thereby include the first content modification profile 576 in the set of matching content modification profiles 570, for example). Alternatively and/or additionally, the second profile matching module 568 may match at least at least a portion of the image to one or more image keys of the set of content keys to determine that the first content modification profile 576 matches at least a portion of the second content item 563 (and thereby include the first content modification profile 576 in the set of matching content modification profiles 570, for example). In some examples, the image may be modified by the content modification module 596 to generate the updated content item 598, which may comprise an updated image. For example, at least a portion of the image (e.g., a portion of the image that is determined to match a key of the set of content keys) may be supplemented with the one or more second supplemental content items, which may comprise at least one of (i) one or more visual objects, (ii) a selectable button pointing to the second internet resource, and/or (iii) one or more other content items.

Embodiments are contemplated in which the first prompt 504 comprise one or more other types of content (e.g., a video, an image, real-time environmental data, geo-spatial information, etc.) as an alternative to and/or in addition to a set of text.

In an example, the first prompt 504 may comprise a video. The profile matching module 518 may generate text representative of at least a portion of the video. The text may comprise (i) a transcript of audio of the video (generated using one or more audio-to-text conversion tools, for example), (ii) a description of one or more actions that occur in the video, and/or (iii) a description of one or more visual objects identified in the video. The profile matching module 518 may match one or more portions of the text to one or more keys (e.g., text-based keys) of the set of prompt keys indicated by the prompt matching configuration 540 to determine that the first prompt modification profile 526 matches at least a portion of the first prompt 504 (and thereby include the first prompt modification profile 526 in the set of matching prompt modification profiles 520, for example). Alternatively and/or additionally, the profile matching module 518 may match at least a portion of one or more video frames of the video to one or more image keys of the set of prompt keys to determine that the first prompt modification profile 526 matches at least a portion of the first prompt 504 (and thereby include the first prompt modification profile 526 in the set of matching prompt modification profiles 520, for example).

In an example, the first prompt 504 may comprise an image. The profile matching module 518 may generate text representative of at least a portion of the image. The text may comprise a description of one or more visual objects identified in the image. The profile matching module 518 may match one or more portions of the text to one or more keys (e.g., text-based keys) of the set of prompt keys indicated by the content matching configuration 590 to determine that the first prompt modification profile 526 matches at least a portion of the first prompt 504 (and thereby include the first prompt modification profile 526 in the set of matching prompt modification profiles 520, for example). Alternatively and/or additionally, the profile matching module 518 may match at least at least a portion of the image to one or more image keys of the set of prompt keys to determine that the first prompt modification profile 526 matches at least a portion of the first prompt 504 (and thereby include the first prompt modification profile 526 in the set of matching prompt modification profiles 520, for example).

Embodiments are contemplated in which the updated content item 598 comprises at least one of text, a video, audio, an image, AR content, MR content, VR content, interactive content, dynamic content, and/or other type of content.

Embodiments are contemplated in which the first content item 556 (e.g., at least one of text, a video, audio, an image, AR content, MR content, VR content, interactive content, dynamic content, and/or other type of content) is provided to the first client device 500 (as an alternative to and/or in addition to providing the updated content item 598 to the first client device 500). The first content item 556 may correspond to an initial content item generated by the generative AI tool 554 based upon the updated prompt 548.

Embodiments are contemplated in which the second content item 563 (e.g., at least one of text, a video, audio, an image, AR content, MR content, VR content, interactive content, dynamic content, and/or other type of content) is provided to the first client device 500 (as an alternative to and/or in addition to providing the updated content item 598 to the first client device 500).

In some examples, user response information associated with a user response associated with the first user and/or the first client device 500 may be recorded by the content system. The user response information may comprise (i) whether the first user selected the first hyperlink 560, the purchase button 599 and/or one or more other supplemental content items included in a content item (e.g., the first content item 556, the second content item 563 and/or the updated content item 598) provided to the first client device 500, (ii) a view time associated with the content item (e.g., how long the content item is displayed on the first client device 500 and/or viewed by the first user), (iii) one or more user response events (e.g., a conversion event) associated with the first user, (iv) an indication of a user satisfaction level of the first user, (v) one or more performance metrics, and/or (vi) one or more other features associated with the first user. In some examples, the user response and/or other user responses associated with the first user and/or other users may be used as feedback to (i) update and/or train the response prediction system and/or the first machine learning model of the response prediction system (e.g., one or more tunable parameters of the first machine learning model may be modified based upon the feedback to more accurately predict user response scores associated with various profiles and/or to more accurately select modification profiles that result in providing content that users respond more positively to) and/or (ii) update and/or train the content system to generate content with visual characteristics that users respond more positively to and/or to format and/or render supplemental content items in a more appealing manner (e.g., the content system may determine that users respond better to hyperlink that are of a first color than a second color, and thus may set hyperlinks such as the first hyperlink 560 to have the first color). It may be appreciated that updating and/or training the content system based upon user responses from users may create a closed-loop process allowing results of content events in which content items are provided to users as feedback to tailor parameters of the content system (such as at least one of modifying content keys used to match content items to content modification profiles, modifying prompt keys used to match prompts to prompt modification profiles, modifying content modification profiles and/or prompt modification profiles, modifying bids, determining features such as keys, bids, content modification profiles and/or prompt modification profiles that offer comparatively greater value than other features, keeping the features and/or removing the other features, etc.). In an example, using the feedback, the content system may determine (i) a maximum number of supplemental content items to add to a content item based upon the feedback, (ii) a first maximum number of selected profiles to be applied by the allocation module 522 for selecting the set of selected profiles 524 for use in modifying the first prompt 504 (e.g., a maximum number of profiles of the set of selected profiles 524) and/or (iii) a second maximum number of selected profiles to be applied by the second allocation module 572 for selecting the second set of selected profiles 574 for use in modifying the second content item 563 to generate the updated content item 598 (e.g., a maximum number of profiles of the second set of selected profiles 574). Closed-loop control may reduce errors and produce more efficient operation of a computer system which implements the content system. The reduction of errors and/or the efficient operation of the computer system may improve operational stability and/or predictability of operation. Accordingly, using processing circuitry to implement closed loop control described herein may improve operation of underlying hardware of the computer system.

In some examples, the content system comprises a reporting system that collects data indicative of auctions (e.g., the first auction and/or the second auction), auction outcomes (e.g., winning profile and/or entity of the first auction and/or the second auction), prompt modifications (e.g., initial prompts such as the first prompt 504, updated prompts such as the updated prompt 548 and/or differences between the initial prompts and the updated prompts), content modifications, and/or user responses (e.g., user response events). The reporting system may report the data to one or more entities (e.g., the first entity and/or the fifth entity) and/or to the response prediction system (to be used as feedback for updating and/or training the response prediction system, for example).

In some examples, different types of supplemental content items may be generated to have different visual characteristics. For example, an informational supplemental content item (e.g., a hyperlink that points to an informational web page that is not a seller page of an advertiser and/or a brand) may have a first font, a first color, a first style, and/or a first formatting, whereas a seller supplemental content item (e.g., a hyperlink that points to a purchasing web page of an advertiser and/or a brand) may have a second font, a second color, a second style, and/or a second formatting, which may be different than the first font, the first color, the first style, and/or the first formatting, respectively. Alternatively and/or additionally, an informational supplemental content item may comprise a first graphical object (e.g., a first symbol, a first image, etc.) that is representative of informational supplemental content items (and/or the first graphical object may be displayed adjacent to the informational supplemental content item). A seller supplemental content item may comprise a second graphical object (e.g., a second symbol, a second image, etc.) that is representative of seller supplemental content items (and/or the second graphical object may be displayed adjacent to the seller supplemental content item). In an example, the first graphical object may be different than the second graphical object (e.g., the first graphical object may comprise a symbol “?” to indicate that a corresponding supplemental content item points to an informational internet resource and/or the second graphical object may comprise a symbol “$” to indicate that a corresponding supplemental content item points to a purchasing page). Thus, a user may be able to distinguish between different types of supplemental content items based upon their visual characteristics.

In some examples, a supplemental content item (e.g., a supplemental content item of the one or more supplemental content items and/or the one or more second supplemental content items included in the second content item 563 and/or the updated content item 598) may be displayed via the first client device 100 using one or more native advertising techniques. For example, a format and/or a style of the supplemental content item may be visually similar to (i) other content comprised within the second content item 563 and/or the updated content item 598 and/or (ii) other content displayed in the content interface 506. In an example where the second content item 563 and/or the updated content item 598 correspond to a recipe, a format and/or a style of the supplemental content item may be configured to look similar to a portion of a recipe. In an example where the content interface corresponds to a conversational interface associated with the conversation between the generative AI tool 554 and the first user, a format and/or a style of the supplemental content item may be configured to look similar to at least a portion of a message from the generative AI tool 554.

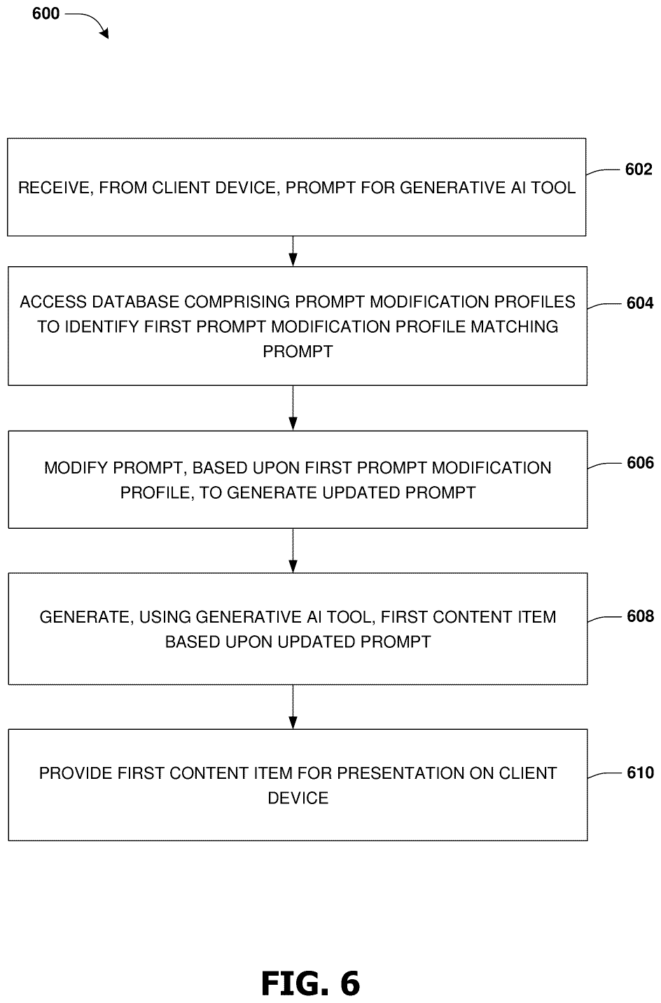

An embodiment of modifying prompts is illustrated by an example method 600 of FIG. 6. At least some of the example method 600 may be performed by the content system. At 602, a prompt (e.g., the first prompt 504) for a generative AI tool (e.g., the generative AI tool 554) may be received from a client device (e.g., the first client device 500). At 604, a database (e.g., the prompt modification profile database 514) may be accessed to identify a first prompt modification profile (e.g., the set of selected profiles 524) matching the prompt. At 606, the prompt may be modified based upon the first prompt modification profile to generate an updated prompt (e.g., using one or more of the techniques provided herein with respect to modifying the first prompt 504 to generate the updated prompt 548). At 608, a first content item may be generated using the generative AI tool based upon the updated prompt (e.g., using one or more of the techniques provided herein with respect to generating the first content item 556 and/or the second content item 563). In an example, the first content item generated at 608 may have one, some and/or all of the features provided herein with respect to the first content item 556 and/or the second content item 563. The first content item generated at 608 may comprise one or more supplemental content items (e.g., at least one of a set of text, a hyperlink, a graphical object, an audio file, an advertisement, one or more informational supplemental content items, one or more seller supplemental content items, etc.). At 610, the first content item may be provided for presentation on the client device. In some examples, one, some and/or all of the techniques provided herein, such as one or more of the techniques provided herein with respect to FIGS. 4 and 5A-5J, may be used to perform at least some of the example method 600.

Embodiments are contemplated in which (i) the prompt is modified based upon the first prompt modification profile to generate the updated prompt, (ii) the prompt (e.g., an unmodified version of the prompt rather than the updated prompt) is used to generate the first content item to be provided to the client device in response to the prompt (e.g., the unmodified version of the prompt is input to the generative AI tool which generates the first content item based upon the unmodified version of the prompt), (iii) the content system provides the first content item (generated based upon the unmodified version of the prompt) to the client device, (iv) the content system provides an indication of the updated prompt (e.g., the content system provides a suggestion to use the updated prompt as a user's next prompt), (v) the content system generates a second content item in response to a selection of the indication of the updated prompt (e.g., using one or more of the techniques provided herein with respect to generating the first content item 556 and/or the second content item 563), wherein the second content item may have one, some and/or all of the features provided herein with respect to the first content item 556 and/or the second content item 563, and/or (vi) the content system provides the second content item to the client device (e.g., the first content item, the second content item and/or the indication of the updated prompt may be displayed on the client device as part of a conversation between the user and the generative AI tool).

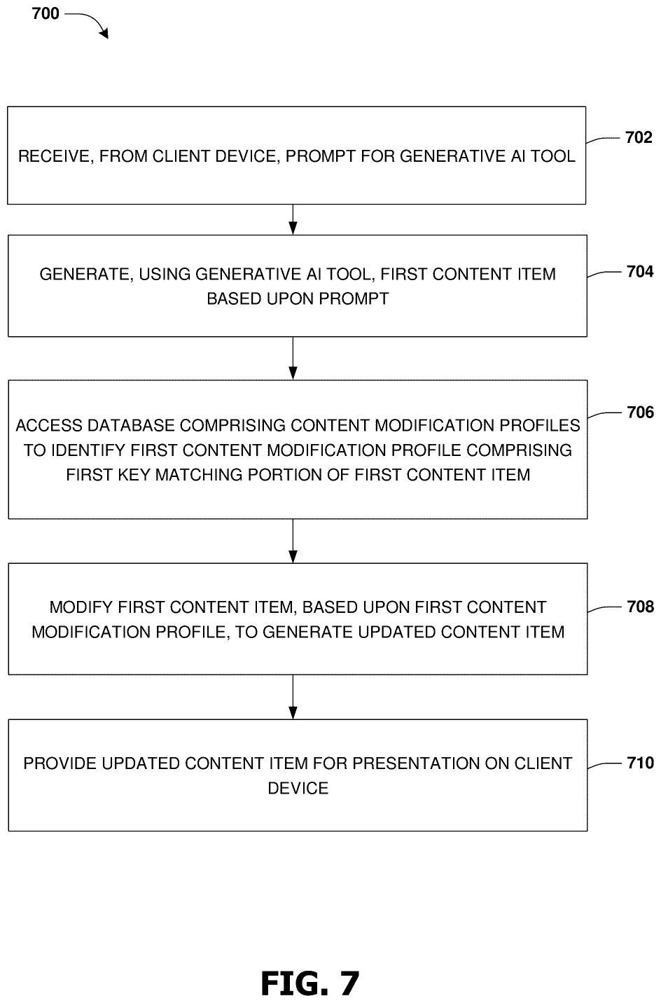

An embodiment of modifying content items is illustrated by an example method 700 of FIG. 7. At least some of the example method 700 may be performed by the content system. At 702, a prompt (e.g., the first prompt 504) for a generative AI tool (e.g., the generative AI tool 554) may be received from a client device (e.g., the first client device 500). At 704, a first content item may be generated using the generative AI tool based upon the prompt (e.g., using one or more of the techniques provided herein with respect to generating the first content item 556 based upon the updated prompt 548). At 706, a database (e.g., the content modification profile database 564) comprising content modification profiles may be accessed to identify a first content modification profile (e.g., the second set of selected profiles 574) comprising a first key (e.g., a content key of the content matching configuration 590) matching at least a portion of the first content item. At 708, the first content item may be modified based upon the first content modification profile to generate an updated content item (e.g., using one or more of the techniques provided herein with respect to modifying the second content item 563 based upon the first content modification profile 576 to generate the updated content item 598). At 710, the updated content item may be provided for presentation on the client device. In some examples, one, some and/or all of the techniques provided herein, such as one or more of the techniques provided herein with respect to FIGS. 4 and 5A-5J, may be used to perform at least some of the example method 700.

In some examples, to ensure user trust and/or compliance with data protection laws, a privacy policy and/or user consent mechanism may be integrated with the content system to manage the content system's capability of modifying content based upon user data. In some examples, the content system may operate according to one or more guidelines and/or ethical standards (to ensure ethical use of AI and/or content modifications meet ethical standards, for example). In some examples, the content system may use a transparent communication protocol to inform users how and/or why their content is being modified. In some examples, a user may set preferences and/or opt in or out of certain types of modifications. For example, the first user profile may be indicative of one or more first types of modifications the first user has opted into and/or one or more first types of modifications the first user has opted out of (e.g., the first user may opt out of prompt modification such that prompts submitted by the first user are not modified based upon prompt modification profiles, and/or may opt into content modification such that content generated using the generative AI tool 554 is modified based upon a content modification profile).

In some examples, implementation of the present disclosure may provide for automatic product placement and/or automatic call to action (for at least one of an advertiser, a campaign of an advertiser, a company, a sponsor, a brand, an organization, a source of information, a publisher, a content creator, etc., for example).

Implementation of at least some of the disclosed subject matter may lead to benefits including a reduction in screen space and/or an improved usability of a display (e.g., of a client device) (e.g., as a result of performing automatic modifications to a prompt and/or a content item to provide a user with one or more supplemental content items that the user may have an interest in, wherein the user may use the one or more supplemental content items to access a desired purchasing page and/or a desired informational internet resource without needing to open a new window and/or search for the purchasing page and/or the informational internet resource, wherein the one or more supplemental content items may be displayed in a contextual manner that does not interrupt an activity session of the user).

In some examples, at least some of the disclosed subject matter may be implemented on a client device, and in some examples, at least some of the disclosed subject matter may be implemented on a server (e.g., hosting a service accessible via a network, such as the Internet).

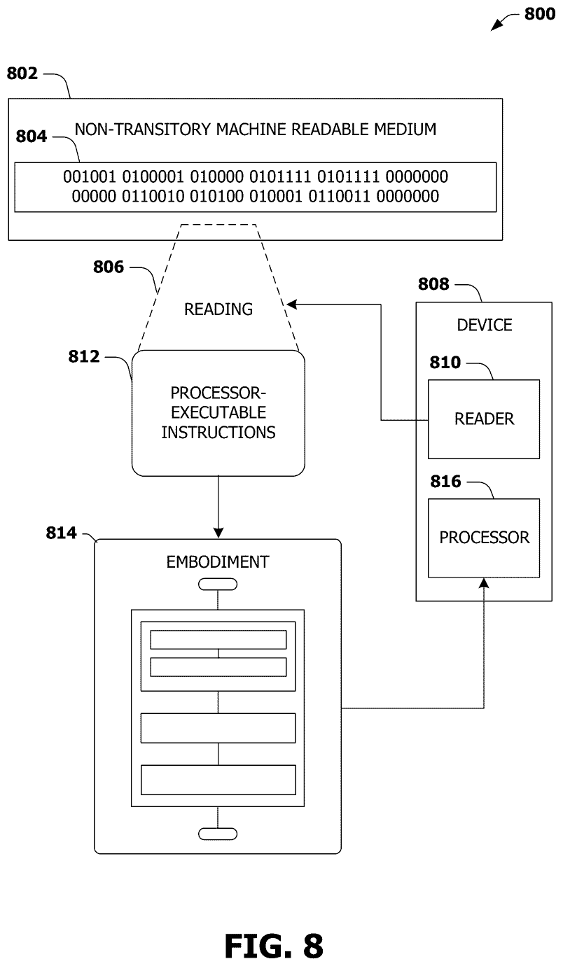

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein (e.g., embodiment 814). The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed, cause performance of operations, such as at least some of the example method 400 of FIG. 4, at least some of the example method 600 of FIG. 6 and/or at least some of the example method 700 of FIG. 7, for example. In some embodiments, the processor-executable instructions 812 are configured to cause implementation of a system, such as at least some of the example system 501 of FIGS. 5A-5J, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving, from a client device, a prompt for a generative artificial intelligence (AI) tool;
accessing a database comprising prompt modification profiles to identify a first prompt modification profile matching the prompt;
modifying the prompt, based upon the first prompt modification profile, to generate an updated prompt;
generating, using the generative AI tool, a first content item based upon the updated prompt; and
providing the first content item for presentation on the client device.

2. The method of claim 1, wherein generating the first content item comprises:
submitting, to the generative AI tool, the updated prompt to generate a second content item;
analyzing the second content item to identify a portion, of the second content item, relevant to a first entity associated with the first prompt modification profile; and
modifying, based upon the portion of the second content item and the first prompt modification profile, the second content item to generate the first content item.

3. The method of claim 2, wherein modifying the second content item to generate the first content item comprises supplementing the second content item with a supplemental content item indicated by the first prompt modification profile to generate the first content item, the method comprising:
receiving, from the client device, a selection of the supplemental content item; and
in response to the selection, directing the client device to an internet resource associated with the first entity.

4. The method of claim 2, wherein:
modifying the second content item to generate the first content item comprises supplementing the second content item with a supplemental content item indicated by the first prompt modification profile to generate the first content item; and
the supplemental content item comprises a link to an internet resource associated with the first entity.

5. The method of claim 2, comprising:
prior to receiving the prompt, receiving an automatic prompt modification request from the first entity; and
storing the first prompt modification profile in the database in response to the automatic prompt modification request, wherein the first prompt modification profile is based upon the automatic prompt modification request.

6. The method of claim 1, comprising:
determining that the first prompt modification profile matches the prompt based upon the prompt comprising a set of text matching a prompt key of the first prompt modification profile.

7. The method of claim 1, comprising:
identifying a plurality of prompt modification profiles, stored in the database, matching the prompt, wherein the plurality of prompt modification profiles comprises the first prompt modification profile;
determining a first score associated with the first prompt modification profile based upon a first bid associated with the first prompt modification profile; and
determining a second score associated with a second prompt modification profile of the plurality of prompt modification profiles based upon a second bid associated with the second prompt modification profile,
wherein the prompt is modified based upon the first prompt modification profile to generate the updated prompt based upon the first score exceeding the second score.

8. The method of claim 1, comprising:
identifying a plurality of prompt modification profiles, stored in the database, matching the prompt, wherein the plurality of prompt modification profiles comprises the first prompt modification profile;
determining a first score associated with the first prompt modification profile based upon at least one of:
a first bid associated with the first prompt modification profile;
a first matching score associated with a relevance of the first prompt modification profile to the prompt; or
a first predicted user experience impact associated with modifying the prompt based upon the first prompt modification profile;
determining a second score associated with a second prompt modification profile of the plurality of prompt modification profiles based upon at least one of:
a second bid associated with the second prompt modification profile;
a second matching score associated with a relevance of the second prompt modification profile to the prompt; or
a second predicted user experience impact associated with modifying the prompt based upon the second prompt modification profile;
assigning a first probability to the first prompt modification profile based upon the first score, wherein the first probability corresponds to a probability that the first prompt modification profile is selected for use in modifying the prompt to generate the updated prompt;
assigning a second probability to the second prompt modification profile based upon the second score, wherein the second probability corresponds to a probability that the second prompt modification profile is selected for use in modifying the prompt to generate the updated prompt; and
selecting the first prompt modification profile according to the first probability and the second probability,
wherein the prompt is modified based upon the first prompt modification profile to generate the updated prompt in response to the selection of the first prompt modification profile.

9. The method of claim 8, comprising:
determining the first predicted user experience impact based upon the first prompt modification profile and a user profile associated with the client device; and
determining the second predicted user experience impact based upon the second prompt modification profile and the user profile.

10. The method of claim 1, wherein modifying the prompt comprises:
supplementing the prompt with a set of text indicated by the first prompt modification profile to generate the updated prompt.

11. A computing device, comprising:
a processor; and
memory comprising processor-executable instructions that when executed by the processor cause performance of operations, the operations comprising:
receiving, from a client device, a prompt for a generative artificial intelligence (AI) tool;
generating, using the generative AI tool, a first content item based upon the prompt;
accessing a database comprising content modification profiles to identify a first content modification profile comprising a first key matching at least a portion of the first content item;
modifying the first content item, based upon the first content modification profile, to generate an updated content item; and
providing the updated content item for presentation on the client device.

12. The computing device of claim 11, wherein modifying the first content item to generate the updated content item comprises:
supplementing the first content item with a supplemental content item indicated by the first content modification profile to generate the updated content item.

13. The computing device of claim 12, the operations comprising:
receiving, from the client device, a selection of the supplemental content item; and
in response to the selection, directing the client device to an internet resource associated with a first entity associated with the first content modification profile.

14. The computing device of claim 12, wherein:
the supplemental content item comprises a link to an internet resource associated with a first entity associated with the first content modification profile.

15. The computing device of claim 13, the operations comprising:
prior to receiving the prompt, receiving an automatic content modification request from the first entity; and
storing the first content modification profile in the database in response to the automatic content modification request, wherein the first content modification profile is based upon the automatic content modification request.

16. The computing device of claim 11, the operations comprising:
determining that the first key of the first content modification profile matches at least the portion of the first content item based upon the first content item comprising a set of text matching a set of text of the first key.

17. The computing device of claim 11, the operations comprising:
identifying a plurality of content modification profiles stored in the database, wherein each of the plurality of content modification profiles is determined to match at least a portion of the first content item, and wherein the plurality of content modification profiles comprises the first content modification profile;
determining a first score associated with the first content modification profile based upon at least one of:
a first bid associated with the first content modification profile;
a first matching score associated with a relevance of the first content modification profile to the first content item; or
a first predicted user experience impact associated with modifying the first content item based upon the first content modification profile; and
determining a second score associated with a second content modification profile of the plurality of content modification profiles at least one of:
a second bid associated with the second content modification profile;
a second matching score associated with a relevance of the second content modification profile to the first content item; or
a second predicted user experience impact associated with modifying the first content item based upon the second content modification profile;
assigning a first probability to the first content modification profile based upon the first score, wherein the first probability corresponds to a probability that the first content modification profile is selected for use in modifying the first content item to generate the updated content item;
assigning a second probability to the second content modification profile based upon the second score, wherein the second probability corresponds to a probability that the second content modification profile is selected for use in modifying the first content item to generate the updated content item; and
selecting the first content modification profile according to the first probability and the second probability,
wherein the first content item is modified based upon the first content modification profile to generate the updated content item in response to the selection of the first content modification profile.

18. The computing device of claim 17, the operations comprising:
determining the first predicted user experience impact based upon the first content modification profile and a user profile associated with the client device; and
determining the second predicted user experience impact based upon the second content modification profile and the user profile.

19. A non-transitory machine-readable medium having stored thereon processor-executable instructions that when executed cause performance of operations, the operations comprising:
receiving, from a client device, a prompt for a generative artificial intelligence (AI) tool;
identifying a first prompt modification profile matching the prompt;
modifying the prompt, based upon the first prompt modification profile, to generate an updated prompt;
generating, using the generative AI tool, a first content item based upon the updated prompt;
identifying a first content modification profile matching at least a portion of the first content item;
modifying the first content item, based upon the first content modification profile, to generate an updated content item; and
providing the updated content item for presentation on the client device.

20. The non-transitory machine-readable medium of claim 19, wherein generating the first content item comprises:
submitting, to the generative AI tool, the updated prompt to generate a second content item;
analyzing the second content item to identify a portion, of the second content item, relevant to a first entity associated with the first prompt modification profile; and
modifying, based upon the portion of the second content item and the first prompt modification profile, the second content item to generate the first content item.
